(19) United States
(12) Patent Application Publication
(10) Pub. No.: US 2005/0239680 A1
(43) Pub. Date: Oct. 27, 2005

(54) Large volume moulded body of washing or cleaning agent

(76) Inventors: Willi Buchmeier, Mettmann (DE); Thomas Juckel, Monhelm (DE)

Correspondence Address: HENKEL CORPORATION, THE TRIAD, SUITE 200, 2200 RENAISSANCE BLVD., GULPH MILLS, PA, 19406, US

(21) Appl. No.: 11/155,905

(22) Filed: Jun. 17, 2005

(30) Foreign Application Priority Data
Dec. 17, 2002 (DE) DE 102 58 870.8

(51) Int. Cl. C11D 17/00

(52) U.S. Cl. 510/446

(57) ABSTRACT

Molded bodies of washing or cleaning agents, the bodies having top and bottom horizontal surfaces defining a height, the top and bottom surfaces being joined by at least two lateral delimiting surfaces, wherein at least one of the lateral delimiting surfaces is not vertical over at least half of the height. The molded bodies are spatially optimized to provide maximum product volume in all automatic dishwasher dosage chamber configurations.

### CROSS REFERENCE TO RELATED APPLICATIONS

This application is a continuation under 35 U.S.C. § 365(c) and 35 U.S.C. § 120 of international application PCT/EP2003/013850, filed Dec. 6, 2003. This application also claims priority under 35 U.S.C. § 119 of DE 102 58 870.8, filed Dec. 17, 2002, which is incorporated herein by reference in its entirety.

### BACKGROUND OF THE INVENTION

The present invention relates to molded bodies of washing or cleaning agents, which have an optimized shape. The present invention particularly relates to molded bodies of cleaning agents for automatic dishwashing, which are used in household dishwashers.

Automatic dishwashing of tableware in household dishwashers normally includes a prewash cycle, a main wash cycle and a rinse cycle, wherein the last two cycles are interrupted by intermediate wash cycles. For some programs—mainly in more expensive machines—the prewash cycle can be switched on for very dirty tableware, or is automatically switched on by means of special turbidity sensors. Generally, however, the consumer selects standard programs without a prewash cycle, such that in the majority of cases a main wash cycle, an intermediate wash cycle and a rinse cycle are carried out.

Normally, in the main wash cycle, water is first fed into the interior of the machine and circulated, so as to heat the water. After a few minutes, the dosage chamber of the machine is opened, releasing the contents, which dissolve in the heated water. There are products on the market that are not intended to be, or cannot be dosed through the dosage chamber. These products can not be used with a prewash cycle, as too much of the product dissolves during the prewash cycle and is pumped out of the machine; if the product were designed in consequence to be less soluble, then solubility problems could arise in the main wash cycle and thus lead to worse cleaning results. Modern products that can be used in association with a prewash cycle must therefore still be dosable using the dosage chamber.

On the other hand, the interior space of the dosage chamber is limited by ecological considerations of the machine manufacturer or for reasons of lack of space. Thus, the trend over the last years has been towards an increased compression of the ingredients so as to be able to deliver the most possible detergent to the main wash cycle. In the automatic dishwashing market, highly compressed detergent tablets have thus achieved market shares in some countries of above 80% of the total market for cleaning products.

Recently, from aesthetic reasons and for the visualization of product advantages, in addition to tablets other molded bodies have been offered, some of them having a plurality of phases. For example, pouches of water-soluble materials can be mentioned here, which contain thickened liquid detergent compositions in combination with large particle size fractions. Molded bodies of water-soluble polymers have been extensively described in the patent literature, manufactured by injection molding, blow molding, deep drawing etc. and subsequently filled with liquid, powdered, granulated or tableted detergents.

The disadvantage of these types of products is that their density is markedly lower than that of detergent tablets. Whereas typical detergent tablets for automatic dishwashers have densities distinctly above 1 g·cm⁻³, (for example ca. 1.25 g·cm⁻³), the density of the cited compositions in water-soluble containers lies distinctly below 1 g·cm⁻³. As a result, the molded bodies in question, for the same volume, contain less detergent, which is available for the cleaning power. Therefore, for given dosage chamber volumes, such products have a marked performance disadvantage in comparison with tablets.

This problem is exacerbated in that a product must fit into all the different automatic dishwashers. As the shape of the dosage chambers has not been normalized, each manufacturer of automatic dishwashers has its own concept, which differs in regard to shape and volume from that of the other manufacturers. As, in addition, the life span of automatic dishwashers can range, for all intents and purposes, up to several decades, depending on the utilization, and the dosage chambers of a manufacturer can also differ from model to model and/or from model year to model year, often the “lowest common denominator” must be found in order to be certain that a detergent matches the dosage chamber of the most important machines of each market.

Especially in regard to lowering the density of visually attractive, new types of product shapes, it is desirable to make use of the greatest possible volume, without thereby generating the previously cited accompanying problems of restricted application in the dosage chambers.

The present invention was based on the object of providing a spatially optimized product form for washing or cleaning agents, which has the greatest possible volume and can also be utilized in the greatest possible number of dosage chambers in automatic dishwashers found in the European market.

It has now been found that molded bodies, which combine the greatest possible volume and accurately fit the greatest possible number of dosage chambers, possess a delimiting, non-vertical surface over at least half of its height.

### DESCRIPTION OF THE INVENTION

The subject of the present invention, in a first embodiment, is a molded body of a laundry or cleaning agent comprising at least two lateral defining surfaces, of which at least one is not vertical over at least half of its height.

For the purposes of the present invention, the term “washing or cleaning agent” signifies a solid body, which comprises detersive substances. This solid body can be, for example, a tablet, which inherently possesses a high density. However, in the context of the present invention, molded bodies are also bodies with an exterior coating that can contain powdered or liquid active substances, for example,

In this case, the exterior coating must—where necessary combined with its enclosed active substances—be sufficiently dimensionally stable to allow the inventive shape to be realized.

Tubular pouches, which deform under their own weight, are therefore unsuitable according to the invention. In the context of the present invention, the term “molded body” therefore includes a particular form stability of the body, such that the body is only deformable from external influences that exceed the normal handling during manufacture, packaging and handling.

The shape of the molded body according to the invention is chosen such that it has at least two lateral limiting surfaces. Here, the term “lateral limiting surfaces” characterizes the surfaces, which are connected together by the horizontal limiting surfaces (in short: top and bottom sides) of the molded body. Accordingly, a normal cylindrical shaped tablet possesses two horizontal limiting surfaces (the circular top and bottom sides) as well as a lateral limiting surface (the cylinder sheath). At least two lateral limiting surfaces can be obtained, for example, by vertically separating a cylindrical tablet into two halves. The resulting bodies have once again two horizontal limiting surfaces (the semicircular shaped top and bottom sides) as well as two lateral limiting surfaces (a semicircular cylindrical sheath and a rectangular lateral surface). In order to achieve an inventive molded body in this example, the cylindrical tablets are transversely divided, i.e. the slicing plane deviates from the vertical. Thus, the right-angled lateral side in the plan view is tipped over from the perpendicular to the horizontal and is consequently no longer vertical.

It is not necessary according to the invention that the whole of the limiting surface is not vertical.

In fact, certain vertical portions do not lead away from the inventive advantages. Therefore, in the above example, a “half-slice” from the vertically divided cylinder could be set on the inventive, transversely divided cylinder. If both cylinders originally had the same height, then exactly the half of the lateral limiting surface is vertical, while the other half is not vertical. The height of the lateral limiting surface is therefore the distance between the top and bottom sides, and thus equal to the height of the molded body. This height is independent of the slope of the limiting surfaces from the vertical. Whereas the distance from the bottom or top side to the lateral limiting surface increases with a decreasing angle between the horizontal and the lateral surface, the height remains constant. The vertical or non-vertical portions of the height can be determined by drawing a perpendicular to the vertical (height) and measurement of each portion for the total height. Of course, according to the invention, it is possible to design a lateral surface such that it first has a vertical portion, then a non-vertical portion, which once more opens out into a vertical portion. This can be required for tablet manufacture and stability, and even distinctly preferred.

According to the invention, molded bodies of washing or cleaning agents are preferred wherein at least one lateral limiting surface is not vertical over at least 60%, preferably over at least 70%, particularly preferably over at least 75% and especially over at least 80% of its height.

Said at least one non-vertical, lateral, limiting surface makes an angle α to the horizontal. According to whether the non-vertical lateral limiting surface tilts “inwards” (i.e. the molded body becomes narrower towards the top) or “outwards” (i.e. the molded body becomes wider towards the top), this angle is greater or smaller than 90°. As by simply turning over the molded body, i.e. exchanging the top and bottom sides, can form the other respective angle, the given angle in the context of the present invention is that which is less than 90°. According to the invention, a non-vertical limiting surface is preferred, which has an angle to the horizontal, which differs by at least 5-10° from the right angle. Molded bodies of washing or cleaning agents according to the invention are those wherein one lateral limiting surface is not vertical over at least half of its height and makes an angle to the horizontal of 30° to 80°, preferably 35° to 75°, particularly preferably 40° to 70° and especially 50° to 60°.

Preferred values for the angle α are, for example, 40, 41, 42, 43, 44, 45, 46, 47, 48, 49, 50, 51, 52, 53, 54, 55, 56, 57, 58, 59, 60, 61, 62, 63, 64 or 65°. From these, particularly preferred values are 48, 49, 50, 51, 52, 53, 54, 55, 56, 57, 58, 59, 60, 61, 62° or non-whole number values between these whole number values.

The shape and number of the lateral surfaces of the inventive molded bodies can vary according to the shape of the horizontal limiting surfaces. Of course, it is also possible that the top and bottom horizontal limiting surfaces have different primary shapes. In regard to the purpose of the present invention, the realization of a greatest possible use of the space, right-angled horizontal limiting surfaces are indeed preferred. From esthetic and/or mechanical grounds, they can have rounded corners. The curvatures can once again be derived from circular segments, whose radii preferably lie between 5 and 15% of the height of the molded body. For two right-angled horizontal limiting surfaces, there are 4 lateral limiting surfaces. If at least one of these is not vertical, according to the invention over at least half of its height, then it follows that the lower side of the inventive molded body is smaller than the upper side.

Of the preferred inventive molded bodies with right-angled, horizontal limiting surfaces, only one lateral limiting surface may not be vertical over at least half of its height. In this case, both of the horizontal limiting surfaces, for example, have the same length x, but different widths b. If two lateral limiting surfaces are not vertical over at least half their height, then these non-vertical lateral surfaces can face each other, such that once again both horizontal limiting surfaces, for example, have the same length but different widths b.

If both the non-vertical lateral sides touch each other, i.e. are “L-shaped”, then both the horizontal limiting surfaces not only have different lengths l, but also different widths b.

In summary, preferred inventive washing or cleaning agent molded bodies are those wherein they have four lateral limiting surfaces, of which one is not vertical over at least half its height, inventive washing or cleaning agent molded bodies being preferred, which are limited by two horizontal surfaces with a right-angled cross-section, which have the same length t and a different width b.

As discussed previously, the corners of the inventive washing or cleaning agent molded bodies can be rounded, for reasons of mechanical stability or of esthetics. In addition, the edges can have a bevel, i.e. can be chamfered. Preferably, the radius of a corner bevel is maximum 1/10 of the length of the shortest side, which neighbors the corner. For beveled edges, the width of the bevel is preferably maximum 1/10 of the width of the narrower of the sides impinging on this edge. In conclusion, preferred inventive washing or cleaning agent molded bodies are those in which the corners of the molded bodies are rounded. Further particularly preferred molded bodies of laundry or cleaning agents are those wherein the edges of the molded body are beveled.

The inventive washing or cleaning agent molded bodies preferably have a height of 10 to 30 mm. Particularly preferred inventive washing or cleaning agent molded bodies have, for example, heights of 12, 13, 14, 15, 16, 17, 18, 19, 20, 21, 22, 23 or 24 mm or values between these whole numbered values. The length of the inventive molded bodies lies preferably between 25 and 60 mm, particularly preferably between 30 and 55 mm, especially between 30 and 55 mm. Exemplary particularly preferred lengths may be cited as: 32 mm, 33 mm, 34 mm, 35 mm, 36 mm, 37 mm, 38 mm, 39 mm, 40 mm, 41 mm or 42 mm, wherein values can also be between these whole numbered values.

The maximum width of the inventive washing or cleaning agent molded body, i.e. the width of the larger horizontal limiting surface, is preferably 20 to 60 mm, particularly preferably 25 to 50 mm. Exemplary particularly preferred widths may be cited as: 30 mm mm, 31 mm, 32 mm, 33 mm, 34 mm, 35 mm, 36 mm, 37 mm, 38 mm, 39 mm, 40 mm, 41 mm or 42 mm, wherein values can also be between these whole numbered values.

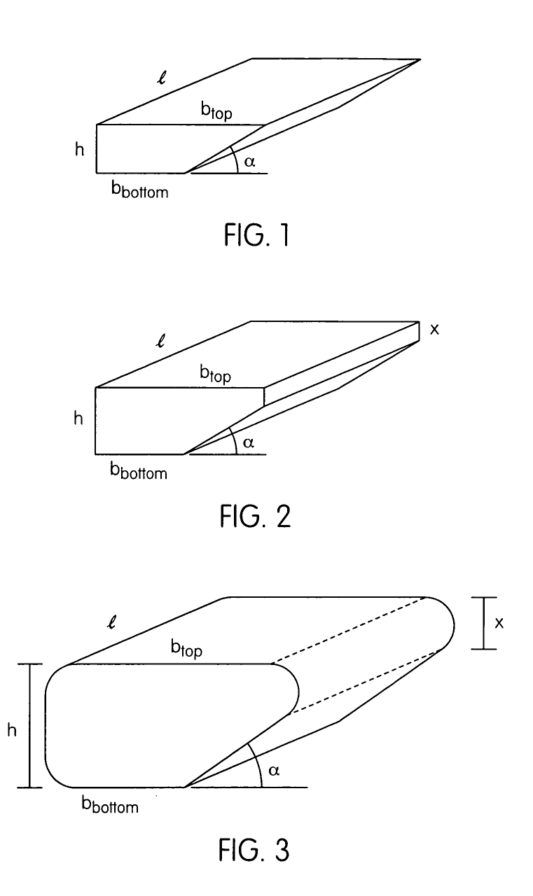

The drawings show exemplary developments of the inventive molded bodies. Accordingly, FIG. 1 shows an inventive washing or cleaning agent molded body, which has two right-angled horizontal limiting surfaces, which have the length l and the width bₜₒₚ and width b_{bottom}. Both surfaces are separated by the distance h, corresponding to the height of the molded body. According to the invention, one lateral limiting surface is formed in such a way that it is not vertical over at least half of its height (here: over the total height).

This lateral limiting surface makes an angle α to the horizontal.

In the following Table, particularly preferred inventive molded bodies, which are represented in FIG. 1, are listed with their values length l, width bₜₒₚ, width b_{bottom}, together with height h and angle α.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

FIG. 2 shows an inventive washing or cleaning agent molded body, which has two right-angled horizontal limiting surfaces, which have the length l and the width bₜₒₚ, and width b_{bottom}. Both surfaces are separated by the distance h, corresponding to the height of the molded body. According to the invention, one lateral limiting surface is formed in such a way that it is not vertical over at least half of its height. Contrary to the molded body shown in FIG. 1, the lateral limiting surface, which is not vertical over at least half its height, is not non-vertical over the total height. In fact, there exists a vertical region of the partial height x, which makes up a quarter of the total, whereby the lateral limiting surface is not vertical over 75% of its height. This lateral limiting surface makes an angle α to the horizontal.

In the following Table, particularly preferred inventive molded bodies, which are represented in FIG. 2 and/or FIG. 3, are listed with their values length l, width bₜₒₚ, width b_{bottom}, together with height h, partial height x and angle α.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

In FIG. 2, the partial height x is shown vertically. In preferred molded bodies, this partial height sector is admittedly rounded off, particularly preferably a semicircle, whose radius is 2.5 to 15%, preferably 5 to 12.5% and especially 6 to 10% of the height h of the molded body. Such a preferred molded body is illustrated in FIG. 3.

The manufacture of the inventive molded body can preferably be carried out from materials, which fulfill a function in the washing or cleaning process, the tableting of the active substance mixture taking a prominent role. A greater variability in shape can admittedly result from the addition of materials, which do not fulfill any specific function in the washing or cleaning process. Here, water-soluble or water-dispersible polymers play a prominent role. The disadvantage of adding additional “ballast” is compensated by the advantages of greater shape variability and possible ingredients as well as by high esthetics.

Variants for the manufacture of the inventive washing or cleaning agent molded body are accordingly preferred, wherein the manufacture includes the compression of a particulate premix to a compressed article.

A further preferred embodiment is constituted by processes for manufacturing inventive molded bodies of washing or cleaning agents, wherein the molded body results from deep drawing and/or casting and/or injection molding and/or blow molding of a water-soluble or water-dispersible polymer or polymer mixture.

The inventive washing or cleaning agent molded bodies particularly correspond then, to the shape illustrated in FIG. 2, if they are obtained by tableting. It is difficult from the technical processing point of view to manufacture molded bodies of the type shown in FIG. 1 by tableting, as the compression stamp runs the risk of touching the matrix of the tablet press at the edge on which the non-vertical limiting surface and the top side meet, thereby damaging the press.

A particularly preferred inventive molded body is when said body is a tablet.

In preferred embodiments of the present invention, the molded body has a high density. Washing and cleaning agent molded bodies are preferred wherein the density is above 1000 kgm⁻³, preferably above 1025 kgm⁻³, particularly preferably above 1050 kgm⁻³ and especially above 1100 kgm⁻³. The tableting process is explained below: It has proved advantageous if the premix, which is to be compressed into tablets, satisfies specific physical criteria. Preferred processes are those wherein the particulate premix has a bulk density of at least 500 g/l, preferably at least 600 g/l and especially at least 700 g/l.

The particle size of the compressed premix also preferably satisfies specific criteria. Preferred processes according to the invention are those in which the particulate premix has a particle size between 100 and 2000 μm, preferably between 200 and 1800 μm, particularly preferably between 400 and 1600 μm and especially between 600 and 1400 μm. A more narrowed particle size of the premixes to be compressed can be adjusted to obtain advantageous properties of the molded bodies. In preferred tableting processes, the compressed particulate premix has a particle size distribution in which less than 10 wt. %, preferably less than 7.5 wt. % and especially less than 5 wt. % of the particles are larger than 1600 μm or smaller than 200 μm. In this connection, narrower particle size distributions are further preferred. Particularly preferred process variants are accordingly those wherein the compressed particulate premix has a particle size distribution, in which more than 30 wt. %, preferably more than 40 wt. % and especially more than 50 wt. % of the particles have a particle size between 600 and 1000 μm.

When carrying out the tableting, one is not limited to the sole use of a particulate premix for compression into a molded body. In fact, the process can be also extended in this sense, to manufacture multi-layer molded bodies in a known manner, in which two or more premixes are prepared and which are compressed on top of each other.

In this context, the premix added first is lightly precompressed to obtain a smooth upper side, which is parallel to the bottom of the molded body, and after filling the second premix, is finally compressed to form the finished molded body. For three or four-layer molded bodies, each premix addition is followed by a precompression, prior to the addition of the last premix, when the molded body is finally compressed.

The molded bodies according to the invention are manufactured first of all by dry-mixing the constituents, some or all of which may have been pregranulated, and subsequently shaping the dry mixture, in particular by compression to tablets, in which context it is possible to have recourse to conventional processes. To produce the molded bodies according to the invention, the premix is compacted in a so-called die between two punches to form a solid compact. This operation, which is referred to below for short as tableting, is divided into four sections: metering, compaction (elastic deformation), plastic deformation, and ejection.

First, the premix is introduced into the die, the fill level and thus the weight and form of the resulting tablet being determined by the position of the lower punch and by the shape of the compression tool. Even in the case of high tablet throughputs, constant metering is preferably achieved by volumetric metering of the premix. In the subsequent course of tableting, the upper punch contacts the premix and is lowered further in the direction of the lower punch. In the course of this compaction, the particles of the premix are pressed closer to one another, with a continual reduction in the void volume within the filling between the punches. When the upper punch reaches a certain position (and thus when a certain pressure is acting on the premix), plastic deformation begins, in which the particles coalesce and the tablet is formed. Depending on the physical properties of the premix, a portion of the premix particles is also crushed and at even higher pressures, there is sintering of the premix. With an increasing compression rate, i.e., high throughputs, the phase of elastic deformation becomes shorter and shorter, with the result that the tablets formed may have larger or smaller voids. In the final step of tableting, the finished tablet is ejected from the die by the lower punch and conveyed away by means of downstream transport means. At this point in time, it is only the weight of the tablet which has been ultimately defined, since the compacts may still change their form and size as a result of physical processes (elastic relaxation, crystallographic effects, cooling, etc).

Tableting takes place in customary commercial tableting presses, which may in principle be equipped with single or double punches. In the latter case, pressure is built up not only using the upper punch; the lower punch as well moves toward the upper punch during the compression operation, while the upper punch presses downward. For small production volumes it is preferred to use eccentric tableting presses, in which the punch or punches is or are attached to an eccentric disk, which in turn is mounted on an axle having a defined speed of rotation. The movement of these compression punches is comparable with the way in which a customary four-stroke engine works. Compression can take place with one upper and one lower punch, or else a plurality of punches may be attached to one eccentric disk, the number of die bores being increased correspondingly. The throughputs of eccentric presses vary, depending on model, from several hundred up to a maximum of 3000 tablets per hour.

For greater throughputs, the apparatus chosen comprises rotary tableting presses, in which a relatively large number of dies is arranged in a circle on a so-called die table. Depending on the model, the number of dies varies between 6 and 55, larger dies also being commercially available.

Each die on the die table is allocated an upper punch and a lower punch, it being possible again for the compressive pressure to be actively built up by the upper punch or lower punch only, or else by both punches. The die table and the punches move around a common, vertical axis, and during rotation the punches, by means of rail-like cam tracks, are brought into the positions for filling, compaction, plastic deformation, and ejection. At those sites where considerable raising or lowering of the punches is necessary (filling, compaction, ejection), these cam tracks are assisted by additional low-pressure sections, low-tension rails, and discharge tracks. The die is filled by way of a rigid supply means, known as the filling shoe, which is connected to a stock vessel for the premix. The compressive pressure on the premix can be adjusted individually for upper punch and lower punch by way of the compression paths, the build up of pressure taking place by the rolling movement of the punch shaft heads past displaceable pressure rolls.

In order to increase the throughput, rotary presses may also be provided with two filling shoes, in which case only one half-circle need be traveled to produce one tablet. For the production of two-layer and multilayer tablets, a plurality of filling shoes is arranged in series, and the gently pressed first layer is not ejected before further filling. By means of an appropriate process regime it is possible in this way to produce laminated tablets and inlay tablets as well, having a construction like that of an onion skin, where in the case of the inlay tablets the top face of the core or of the core layers is not covered and therefore remains visible. Rotary tableting presses can also be equipped with single or multiple tools, so that, for example, an outer circle with 50 bores and an inner circle with 35 bores can be used simultaneously for compression. The throughputs of modern rotary tableting presses reach more than a million tablets per hour.

When tableting with rotary presses, it has been found advantageous to perform tableting with minimal fluctuations in tablet weight. Fluctuations in tablet hardness can also be reduced in this way. Low variations in weight can be achieved as follows:
use of plastic inserts with small thickness tolerances
low rotor speed
large filling shoes
harmonization between the filling shoe wing rotary speed and the speed of the rotor
filling shoe with constant powder level
decoupling of filling shoe and powder charge

To reduce caking on the punches, all of the anti-adhesion coatings known from the art are available. Polymer coatings, plastic inserts or plastic punches are particularly advantageous. Rotating punches have also been found advantageous, in which case, where possible, upper punch and lower punch should be of rotatable configuration. In the case of rotating punches, it is generally possible to do without a plastic insert. In this case, the punch surfaces should be electro polished.

It has also been found that long compression times are advantageous. These times can be established using pressure rails, a plurality of pressure rolls, or low rotor speeds. Since the fluctuations in tablet hardness are caused by the fluctuations in the compressive forces, systems should be employed which limit the compressive force. In this case, it is possible to use elastic punches, pneumatic compensators, or sprung elements in the force path.

In addition, the pressure roll may be of sprung design.

In the context of the present invention, preferred tableting processes are those wherein the compression is carried out using press pressures of 0.01 to 50 kNcm⁻², preferably 0.1 to 40 kNcm⁻² and especially 1 to 25 kNcm⁻².

In the context of the present invention, suitable tableting machines are obtainable, for example, from the following companies: Apparatebau Holzwarth GbR, Asperg, Wilhelm Fette GmbH, Schwarzenbek, Hofer GmbH, Weil, Horn & Noack Pharmatechnik GmbH, Worms, IMA Verpackungssysteme GmbH, Viersen, KILIAN, Cologne, KOMAGE, Kell am See, KORSCH Pressen AG, Berlin, and Romaco GmbH, Worms. Examples of further suppliers are Dr. Herbert Pete, Vienna (AU), Mapag Maschinenbau AG, Berne (CH), BWI Manesty, Liverpool (GB), I. Holland Ltd., Nottingham (GB), Courtoy N.V., Halle (BE/LU), and Medicopharm, Kamnik (SI). A particularly suitable apparatus is, for example, the hydraulic double-pressure press HPF 630 from LAEIS, D.

Tableting tools are obtainable, for example, from the following companies: Adams Tablettierwerkzeuge, Dresden, Wilhelm Fett GmbH, Schwarzenbek, Klaus Hammer, Solingen, Herber & Sohne GmbH, Hamburg, Hofer GmbH, Weil, Horn & Noack, Pharmatechnik GmbH, Worms, Ritter Pharmatechnik GmbH, Hamburg, Romaco GmbH, Worms, and Notter Werkzeugbau, Tamm. Further suppliers are, for example, Senss AG, Reinach (CH) and Medicopharm, Kamnik (SI).

As an alternative to this, the inventive washing or cleaning agent molded body can also be manufactured by other ways, wherein the manufacture of a suitably shaped sheathing, which can be filled, is of particular importance. Accordingly, washing or cleaning agent molded bodies, which are a filled and closed deep drawn part and/or injection molded part and/or blow molded part are a further preferred embodiment of the present invention.

The manufacture of inventive washing or cleaning agent molded bodies by deep drawing and/or casting and/or injection molding and/or blow molding of a water-soluble or water-dispersible polymer or polymer mixture is explained below: The manufacture of filled or unfilled hollow articles using forming processes is carried out according to customary processes of the plastic processing industry, wherein particularly film manufacturing and subsequent film treatment, blow molding and injection molding are preferred. Common to all these processes is that a polymer granule is melted by means of an extruder and brought to shape-giving tools.

In a preferred embodiment of the present invention, the melt that leaves the extruder is blow molded. Suitable blow molding processes according to the invention are extrusion blowing, coextrusion blowing, injection-stretch blowing and dip blowing. Different wall thicknesses according to the area of the molded object can be produced by blow molding, whereby the wall thicknesses of the extrudate are made up, preferably along its vertical axis, of corresponding different thicknesses, preferably by regulating the amount of thermoplastic material, preferably by means of an adjustable spindle at the exit of the extrudate from the extruder.

The powder-filled or liquid-filled solid can be blow molded with areas of different outer dimensions and constant wall thicknesses whereby the wall thicknesses of the extrudate are made up, preferably along its vertical axis, of corresponding different thicknesses, preferably by regulating the amount of thermoplastic material, preferably by means of an adjustable spindle at the exit of the extrudate from the extruder.

In this manner, the different geometrical designs of the molded body can be blow molded with and without compartments. Bottles, spheres, Father Christmases, Easter rabbits or other figures, which can be filled with product, can be blow molded in a single work step.

It is particularly advantageous that the molded body can be embossed and/or decorated in the blow mold during blow molding. A mirror image of a motive can be transferred onto the molded body by the corresponding design of the mold. In this manner, the surface of the molded body can have practically any design. For example, information such as gauging lines, indications for use, danger symbols, trademarks, weight, quantities, end-use date, pictures etc., can be imprinted.

The walls of hollow articles made by blow molding have a wall thickness between 0.05-5 mm, particularly between 0.06-2 mm, preferably between 0.07-1.5 mm, further preferred between 0.08-1.2 mm, even more preferred between 0.09-1 mm and most preferred between 0.1-0.6 mm.

The filling opening of the hollow article after filling is liquid-tight sealed, it being preferred that corresponding rims be foreseen around the opening during blow molding.

In another preferred embodiment of the present invention, the melt of the water-soluble polymer blend that leaves the extruder is shaped by an injection molding process. Injection molding is a well known process using high pressures and temperatures comprising the steps: closing the mold that is contacted by the injection molding extruder, injecting the polymer at high temperature and high pressure, cooling the injected article, opening the mold and removing the shaped article. Additional optional steps, such as applying mold release agents, ejection etc., are known to the expert and may be carried out by well-known technologies.

The advantages of the processing technique for manufacturing by injection molding, are in the mature technology of this processing technique, the high flexibility in relation to the usable materials, the possibility of obtaining exactly defined wall thicknesses of the article or shaped hollow article and the possibility of manufacturing in one step, with high reproducibility, a shaped hollow article having one or more integrated separation arrangement(s).

In preferred processes, injection molding is carried out at up to 5000 bar, particularly between 2 and 2500 bar, particularly preferably between 5 and 2000 bar, even more preferably between 10 and 1500 bar and especially between 100 and 1250 bar.

The temperature of the injection molded material preferably lies above the melting point or softening point of the material and therefore depends on the type and composition of the polymer blend. In preferred processes according to the invention, injection molding is carried out at temperatures between 100 and 250° C., particularly between 120 and 200° C. and especially between 140 and 180° C.

The tooling, which receive the materials, are preferably temperature maintained and have temperatures above room temperature, temperatures between 25 and 60° C. and especially between 35 and 50° C. being preferred.

The thickness of the wall can be varied independently of the material used for the hollow article, but as a function of the desired dissolution properties. Consequently, the wall should be thin enough for an efficient dissolution or disintegration to be attained and an efficient liberation of the ingredients into the wash liquor; however a certain minimum thickness is required, in order to lend the hollow article the desired stability, particularly shape stability.

Preferred wall thicknesses of injection molded bodies are in the range 100 to 5000 μm, preferably 200 to 3000 μm, particularly preferably 300 to 2000 μm and especially 500 to 1500 μm.

Routinely, molded bodies manufactured by injection molding do not have closed walls on all sides; at least one of its sides is open, due to the manufacturing process. One or more preparations are filled through the remaining opening into the compartment(s) formed inside the molded body. This occurs similarly by well-known methods, for example, techniques known from the confectionary industry; multi-step process techniques are also imaginable.

A one-step process technique is especially preferred, when liquid components, including preparations (dispersions or emulsions, suspensions) or even gaseous components including preparations (foams) are also intended to be added in addition to solid preparations.

Deep drawing involves a film of suitable material being placed over a mold having recesses, optionally heated and then drawn into the recess by means of reduced pressure.

Alternatively, or in addition, the film can be pressed into the mold by applying a pressure on the upper side or by means of a punch. Preferred wall thicknesses of deep drawn molded bodies are in the range 100 to 5000 μm, preferably 200 to 3000 μm, particularly preferably 300 to 2000 μm and especially 500 to 1500 μm.

For the hollow articles made of water-soluble or water dispersible polymers, all polymers can be considered, which could also be used for an optionally used sealing film. These will be described below.

The polymers used for the film materials can consist of a single material or a blend of different materials. Preferred film materials are derived from the group (of optionally acetalized) polyvinyl alcohol (PVAL) and/or PVAL copolymers, polyvinyl pyrrolidone, polyethylene oxide, polyethylene glycol, gelatin, and/or copolymers as well as their mixtures.

In the context of the present invention, polyvinyl alcohols are particularly preferred. “Polyvinyl alcohols” (abbreviation PVAL, sometimes also PVOH) is the term for polymers with the general structure 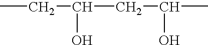
which comprise lesser amounts (ca. 2%) of structural units of the type

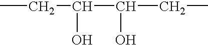

Typical commercial polyvinyl alcohols, which are offered as yellowish white powders or granules having degrees of polymerization in the range of approx. 100 to 2500 (molar masses of approximately 4000 to 100 000 g/mol), have degrees of hydrolysis of 98-99 or 87-89 molar % and thus still have a residual acetyl group content. The manufacturers characterize the polyvinyl alcohols by stating the degree of polymerization of the initial polymer, the degree of hydrolysis, the saponification number and/or the solution viscosity.

The solubility in water and in a few strongly polar organic solvents (formamide, dimethylformamide, dimethyl sulfoxide) of polyvinyl alcohols is a function of the degree of hydrolysis; they are not attacked by (chlorinated) hydrocarbons, esters, fats or oils. Polyvinyl alcohols are classed as toxicologically unobjectionable and are at least partially biodegradable. The solubility in water can be reduced by post-treatment with aldehydes (acetalization), by complexing with Ni salts or Cu salts or by treatment with dichromates, boric acid or borax. The coatings of polyvinyl alcohol are substantially impenetrable for gases such as oxygen, nitrogen, helium, hydrogen, carbon dioxide, but do allow water vapor to pass.

Preferred processes in the context of the present invention are characterized in that the water-soluble envelope comprises polyvinyl alcohols and/or PVAL copolymers whose degree of hydrolysis is from 70 to 100 molar %, preferably from 80 to 90 molar %, with particular preference from 81 to 89 molar %, and in particular from 82 to 88 molar %.

Preferably, polyvinyl alcohols of a defined molecular weight range are used, wherein preferred portion packaging according to the invention are those where the water-soluble envelope comprises polyvinyl alcohols and/or PVAL copolymers whose molecular weight lies in the range 3500 to 100 000 gmol⁻¹, preferably from 10 000 gmol−1 to 90 000 gmol⁻¹, with particular preference from 12 000 to 80.000 gmol⁻¹, and in particular from 13 000 to 70 000 gmol⁻¹.

The degree of polymerization of such preferred polyvinyl alcohols lies between approximately 200 to approximately 2100, preferably between approximately 220 to approximately 1890, with particular preference between approximately 240 to approximately 1680, and in particular between approximately 260 to approximately 1500.

According to the invention, preferred processes are those wherein the film comprises polyvinyl alcohols and/or PVAL copolymers whose average degree of polymerization lies between 80 and 700, preferably between 150 and 400, particularly preferably between 180 and 300 and/or whose molecular weight ratio MG (50%) to MG (90%) lies between 0.3 and 1, preferably between 0.4 and 0.8 and particularly between 0.45 and 0.6.

The above-described polyvinyl alcohols are widely commercially available, for example under the trade name Mowiol® (Clariant). Examples of polyvinyl alcohols which are particularly suitable in the context of the present invention are Mowiol® 3-83, Mowiol® 4-88, Mowiol® 5-88, and Mowiol® 8-88.

Further polyvinyl alcohols that are particularly suitable as materials for the film materials are to be found in the following table:

| | Degree of | Molecular Weight | Melting Point |
|---|---|---|---|
| Description | Hydrolysis [%] | [kDa] | [° C.] |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® | 30-28 | 23.600 | 100 |
| 5407 | | | |
| Gohsefimer ® | 41-51 | 17.700 | 100 |
| LL02 | | | |

Further polyvinyl alcohols that are suitable as materials for the film are ELVANOL® 51-05, 52-22, 50-42, 85-82, 75-15, T-25, T-66, 90-50 (trade mark of Du Pont), ALCOTEX® 72.5, 78, B72, F80/40, F88/4, F88/26, F88/40, F88/47 (trade mark of Harlow Chemical Co.), Gohsenol® NK-05, A-300, AH-22, C-500, GH-20, GL-03, GM-14L, KA-20, KA-500, KH-20, KP-06, N-300, NH-26, NM11Q, KZ-06 (trade mark of Nippon Gohsei K. K.). ERKOL types from Wacker are also suitable.

A further preferred group of water-soluble polymers that according to the invention can serve as envelopes, are polyvinyl pyrrolidones. These are marketed, for example, under the designation Luviskol® (BASF). Polyvinyl pyrrolidones [poly(1-vinyl-2-pyrrolidinones)], abbreviated PVP, are polymers of the general formula (A) 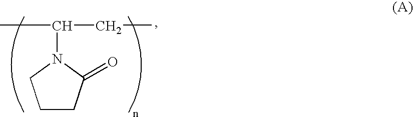
prepared by free-radical polymerization of 1-vinyl pyrrolidone by solution or suspension polymerization processes using free-radical initiators (peroxides, azo compounds). The ionic polymerization of the monomer yields only products with low molecular weights. Typical commercial polyvinyl pyrrolidones have molecular weights in the range of approx. 2500-750 000 g/mol, which are characterized by stating the K values and K value-dependent glass transition temperatures of 130-175° C. They are supplied as white, hygroscopic powders or as aqueous solutions. Polyvinyl pyrrolidones are readily soluble in water and a large number of organic solvents (alcohols, ketones, glacial acetic acid, chlorinated hydrocarbons, phenols, etc).

Copolymers of vinyl pyrrolidones with other monomers, particularly vinyl pyrrolidone-vinyl ester copolymers, are also suitable, as marketed for example under the trademark Luviskol® (BASF). Luviskol® VA 64 and Luviskol® VA 73, each vinyl pyrrolidone-vinyl acetate copolymers, are particularly preferred nonionic polymers.

The vinyl ester polymers are polymers obtainable from vinyl esters with the groups of formula (B) 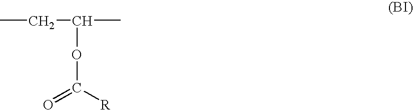
as the characteristic basic structural unit of the macromolecules. Of these, the vinyl acetate polymers (R═CH₃) with polyvinyl acetates are by far the most important representatives and have the greatest industrial significance.

The vinyl esters are polymerized free-radically by various processes (solution polymerization, suspension polymerization, emulsion polymerization, and bulk polymerization). Copolymers of vinyl acetate with vinyl pyrrolidone comprise monomer units of the formulae (A) and (B).

Further suitable water-soluble polymers are the polyethylene glycols (polyethylene oxides), which are abbreviated as PEG. PEG are polymers of ethylene glycol and satisfy the general formula (C)
H—(O—CH₂—CH₂)ₙ—OH (C),
where n can assume values between 5 and >100 000.

PEGs are industrially manufactured mainly by the anionic ring opening polymerization of ethylene oxide (oxirane) in the presence of small amounts of water. Depending on the reaction conditions, they have molecular weights in the range ca. 200-5 000 000, corresponding to polymerization degrees of ca. 5 to >100 000.

Products with molecular weights<25 000 g/mol are liquids at room temperature and are described as true polyethylene glycols, abbreviation PEG. These short-chain PEGs can be added, especially as plasticizers, to other water-soluble polymers e.g. polyvinyl alcohols or cellulose ethers. The polyethylene glycols, which are solid at room temperature and used according to the invention, are described as polyethylene oxides, abbreviation PEOX.

High molecular weight polyethylene oxides possess an extremely low concentration of reactive hydroxyl end groups and therefore show only slight properties of glycols.

According to the invention, another further suitable film material is gelatin, this being preferably used together with other polymers. Gelatin is a polypeptide (molecular weight: approx. 15 000 to >250 000 g/mol) obtained principally by hydrolysis under acidic or alkaline conditions of the collagen present in the skin and bones of animals. The amino acid composition of gelatin corresponds largely to that of the collagen from which it was obtained, and varies as a function of its provenance. The use of gelatin as a water-soluble coating material is extremely widespread, especially in pharmacy, in the form of hard or soft gelatin capsules. Gelatin in the form of films finds only limited use, due to its high price compared with the above-cited polymers.

Further suitable water-soluble polymers for the film according to the invention are described below:
Cellulose ethers, such as hydroxypropyl cellulose, hydroxyethyl cellulose and methyl hydroxypropyl cellulose, as marketed for example under the trademarks Culminal® and Benecel® (AQUALON).
Cellulose ethers can be described by means of the general Formula (D): 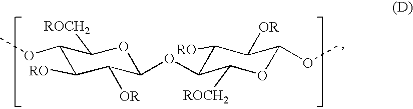
   where R is H or an alkyl, alkenyl, alkynyl, aryl or alkylaryl radical. In preferred products, at least one R in formula (III) is —CH₂CH₂CH₂—OH or —CH₂CH₂—OH. Cellulose ethers are prepared industrially by etherifying alkali metal cellulose (e.g., with ethylene oxide). Cellulose ethers are characterized by way of the average degree of substitution, DS, and/or by the molar degree of substitution, MS, which indicate how many hydroxyl groups of an anhydroglucose unit of cellulose have reacted with the etherifying reagent or how many moles of the etherifying reagent have been added on, on average, to one anhydroglucose unit. Hydroxyethyl celluloses are water-soluble above a DS of approximately 0.6 and an MS of approximately 1. Typical commercial hydroxyethyl- and hydroxypropyl celluloses have degrees of substitution in the range of 0.85-1.35 (DS) and 1.5-3 (MS), respectively. Hydroxyethyl- and -propyl celluloses are marketed as yellowish white, odorless and tasteless powders in greatly varying degrees of polymerization. Hydroxyethyl- and -propyl celluloses are soluble in cold and hot water and in some (water-containing) organic solvents, but insoluble in the majority of (water-free) organic solvents; their aqueous solutions are relatively insensitive to changes in pH or addition of electrolyte.

Further suitable polymers according to the invention are water-soluble amphopolymers. The generic term amphopolymers embraces amphoteric polymers, i.e., polymers whose molecule includes both free amino groups and free —COOH or SO₃H groups and are capable of forming inner salts; zwitterionic polymers whose molecule contains quaternary ammonium groups and —COO⁻ or —SO₃⁻ groups, and polymers containing —COOH or SO₃H groups and quaternary ammonium groups. An example of an amphopolymer which may be used in accordance with the invention is the acrylic resin obtainable under the designation Amphomer®, which constitutes a copolymer of tert-butylaminoethyl methacrylate, N-(1,1,3,3-tetramethylbutyl)acrylamide, and two or more monomers from the group consisting of acrylic acid, methacrylic acid and their simple esters. Likewise preferred amphopolymers are composed of unsaturated carboxylic acids (e.g., acrylic and methacrylic acid), cationically derivatized unsaturated carboxylic acids, (e.g., acrylamidopropyltrimethylammonium chloride), and, if desired, further ionic or nonionic monomers together with terpolymers of acrylic acid, methyl acrylate and methacrylamidopropyltrimonium chloride, as available commercially under the designation Merquat® 2001 N, are particularly preferred amphopolymers in accordance with the invention. Further suitable amphoteric polymers are, for example, the octylacrylamide methyl methacrylate tert-butylaminoethyl methacrylate 2-hydroxypropyl methacrylate copolymers available under the designations Amphomer® and Amphomer® LV-71 (DELFT NATIONAL).

Water-soluble anionic polymers that are suitable in accordance with the invention include:
vinyl acetate-crotonic acid copolymers, as are commercialized, for example, under the designations Resyn® (NATIONAL STARCH), Luviset® (BASF), and Gafset® (GAF). In addition to monomer units of the abovementioned formula (II), these polymers also have monomer units of the general formula (E):
   [—CH(CH₃)—CH(COOH)—]ₙ (E)
vinyl pyrrolidone-vinyl acrylate copolymers, obtainable for example under the trademark Luviflex® (BASF). A preferred polymer is the vinyl pyrrolidone-acrylate terpolymer obtainable under the designation Luviflex® VBM-35 (BASF).
acrylic acid-ethyl acrylate-N-tert-butylacrylamide terpolymers, which are marketed for example under the designation Ultrahold® strong (BASF).
graft polymers of vinyl esters, esters of acrylic acid or methacrylic acid alone or in a mixture, copolymerized with crotonic acid, acrylic acid or methacrylic acid with polyalkylene oxides and/or polyalkylene glycols.

Such grafted polymers of vinyl esters, esters of acrylic acid or methacrylic acid alone or in a mixture with other copolymerizable compounds onto polyalkylene glycols are obtained by polymerization under heating in a homogeneous phase, by stirring the polyalkylene glycols into the monomers of the vinyl esters, esters of acrylic acid or methacrylic acid, in the presence of free-radical initiator.
Vinyl esters which have been found suitable are, for example, vinyl acetate, vinyl propionate, vinyl butyrate, vinyl benzoate, and those esters of acrylic acid or methacrylic acid obtainable from low molecular weight aliphatic alcohols, i.e., in particular, ethanol, propanol, isopropanol, 1-butanol, 2-butanol, 2-methyl-1-propanol, 2-methyl-2-propanol, 1-pentanol, 2-pentanol, 3-pentanol, 2,2-dimethyl-1-propanol, 3-methyl-1-butanol; 3-methyl-2-butanol, 2-methyl-2-butanol, 2-methyl-1-butanol, and 1-hexanol.

Polypropylene glycols (abb. PPG) are polymers of propylene glycol which correspond to general formula (F) 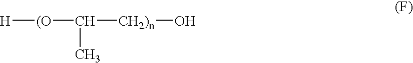
wherein n can take values between 1 (propylene glycol) and about 1000. In this case the industrially significant representatives are, in particular, di-, tri- and tetrapropylene glycol, i.e., the representatives where n=2, 3 and 3 in formula VI.

In particular, vinyl acetate copolymers grafted onto polyethylene glycols and the polymers of vinyl acetate and crotonic acid grafted onto polyethylene glycols can be used.
grafted and crosslinked copolymers from the copolymerization of
   i) at least one monomer of the nonionic type,
   ii) at least one monomer of the ionic type,
   iii) polyethylene glycol, and
   iv) a crosslinker

The polyethylene glycol used has a molecular weight of between 200 and several million, preferably between 300 and 30 000.

The nonionic monomers may be of very different types, and include the following preferred monomers: vinyl acetate, vinyl stearate, vinyl laurate, vinyl propionate, allyl stearate, allyl laurate, diethyl maleate, allyl acetate, methyl methacrylate, cetyl vinyl ether, stearyl vinyl ether, and 1-hexene.

The nonionic monomers may equally be of very different types, among which particular preference is given to the presence in the graft polymers of crotonic acid, allyloxyacetic acid, vinylacetic acid, maleic acid, acrylic acid, and methacrylic acid.

Preferred crosslinkers are ethylene glycol dimethacrylate, diallyl phthalate, ortho-, meta- and para divinylbenzene, tetraallyloxyethane, and polyallylsaccharoses containing 2 to 5 allyl groups per molecule of saccharin.

The above described grafted and crosslinked copolymers are formed preferably of:
i) from 5 to 85% by weight of at least one monomer of the nonionic type,
ii) from 3 to 80% by weight of at least one monomer of the ionic type,
iii) 2 to 50% by weight, preferably 5 to 30% by weight, of polyethylene glycol, and
iv) 0.1 to 8% by weight of a crosslinker, the percentage of the crosslinker being defined by the ratio of the overall weights of i), ii) and iii).
   copolymers obtained by copolymerizing at least one monomer from each of the three following groups:
      i) esters of unsaturated alcohols and short-chain saturated carboxylic acids and/or esters of short-chain saturated alcohols and unsaturated carboxylic acids,
      ii) unsaturated carboxylic acids,
      iii) esters of long-chain carboxylic acids and unsaturated alcohols and/or esters of the carboxylic acids of group ii) with saturated or unsaturated, straight-chain or branched C₈₋₁₈ alcohols

Short-chain carboxylic acids and alcohols here are those having 1 to 8 carbon atoms, it being possible for the carbon chains of these compounds to be interrupted, if desired, by divalent hetero-groups such as —O—, —NH—, and —S—.
terpolymers of crotonic acid, vinyl acetate, and an allyl or methallyl ester

These terpolymers contain monomer units of the general formula (D) and (E) (see above) and monomer units from one or more allyl or methallyl esters of formula (G): 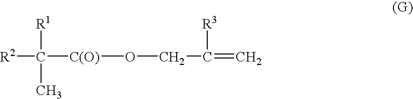
in which R³ is —H or —CH₃, R² is —CH₃ or —CH(CH₃)₂ and R¹ is —CH₃ or a saturated straight-chain or branched C₁₋₆ alkyl radical and the sum of the carbon atoms in the radicals R¹ and R² is preferably 7, 6, 5, 4, 3 or 2.

The abovementioned terpolymers result preferably from the copolymerization of from 7 to 12% by weight of crotonic acid, from 65 to 86% by weight, preferably from 71 to 83% by weight, of vinyl acetate and from 8 to 20% by weight, preferably from 10 to 17% by weight, of allyl or methallyl esters of the formula (G).
tetra- and pentapolymers of
   i) crotonic acid or allyloxyacetic acid
   ii) vinyl acetate or vinyl propionate
   iii) branched allyl or methallyl esters
   iv) vinyl ethers, vinyl esters or straight chain allyl or methallyl esters
crotonic acid copolymers with one or more monomers from the group consisting of ethylene, vinylbenzene, vinyl methyl ether, acrylamide and the water-soluble salts thereof
terpolymers of vinyl acetate, crotonic acid and vinyl esters of a saturated aliphatic α-branched monocarboxylic acid.

Further preferred polymers, which may be used according to the invention as film material, are cationic polymers. Among the cationic polymers, the permanently cationic polymers are preferred. “Permanently cationic” refers according to the invention to those polymers, which independently of pH have a cationic group. These are generally polymers, which contain a quaternary nitrogen atom, in the form of an ammonium group, for example.

Examples of preferred cationic polymers are
quaternized cellulose derivatives, as available commercially under the designations Celquat® and Polymer JR®. The compounds Celquat® H 100, Celquat® L 200 and Polymer JR® 400 are preferred quaternized cellulose derivatives.
Polysiloxanes with quaternary groups, such as, for example, the commercially available products Q2-7224 (manufacturer: Dow Corning; a stabilized trimethylsilylamodimethicone), Dow Corning® 929 emulsion (comprising a hydroxylamino-modified silicone, also referred to as amodimethicone), SM-2059 (manufacturer: General Electric), SLM-55067 (manufacturer: Wacker), and Abil®-Quat 3270 and 3272 (manufacturer: Th. Goldschmidt; diquaternary polydimethylsiloxanes, Quaternium-80),
Cationic guar derivatives, such as in particular the products marketed under the trade names Cosmedia® Guar and Jaguar®,
Polymeric dimethyldiallylammonium salts and their copolymers with esters and amides of acrylic acid and methacrylic acid. The products available commercially under the designations Merquat® 100 (poly(dimethyldiallylammonium chloride)) and Merquat® 550 (dimethyldiallylammonium chloride-acrylamide copolymer) are examples of such cationic polymers.
Copolymers of vinyl pyrrolidone with quaternized derivatives of dialkylamino acrylate and methacrylate, such as, for example, vinyl pyrrolidone-dimethylamino methacrylate copolymers quaternized with diethyl sulfate. Such compounds are available commercially under the designations Gafquat® 734 and Gafquat® 755.
Vinyl pyrrolidone-methoimidazolinium chloride copolymers, as offered under the designation Luviquat®.
Quaternized polyvinyl alcohol
   and also the polymers known under the designations
Polyquaternium 2,
Polyquaternium 17,
Polyquaternium 18 and
Polyquaternium 27
   having quaternary nitrogen atoms in the polymer main chain. These polymers are designated in accordance with the INCI nomenclature; detailed information can be found in the CTFA International Cosmetic Ingredient Dictionary and Handbook, 5thh Edition, The Cosmetic, Toiletry and Fragrance Association, Washington, 1997, expressly incorporated herein by reference.

Preferred cationic polymers in accordance with the invention are quaternized cellulose derivatives and also polymeric dimethyldiallylammonium salts and copolymers thereof. Cationic cellulose derivatives, especially the commercial product Polymer® JR 400, are especially preferred cationic polymers.

Independently of whether the inventive molded bodies are manufactured by tableting or by other processes, they comprise active substances for a washing or cleaning process. For the case where the tablets form the inventive molded bodies, then various active substances can be comprised in the tablets. When the inventive molded bodies are manufactured by other processes, it is indeed also possible that the hollow bodies already contain active substances (for example dyes, enzymes, optical brighteners, redispersion agents, sequestrants etc., i.e. so called minor components); the major quantity of the active substance is to be found in the filling, however.

The preferred ingredients of the inventive washing or cleaning agent molded bodies are illustrated below.

In this context, particularly preferred active washing and cleaning substances are added from the group of bleaches, bleach activators, polymers, builders, surfactants, enzymes, disintegration aids, electrolytes, pH adjustors, fragrances, perfume carriers, dyes, hydrotropes, foam inhibitors, anti-redeposition agents, optical brighteners, graying inhibitors, crack retardants, anti-crease agents, color transfer inhibitors, antimicrobials, germicides, fungicides, antioxidants, corrosion inhibitors, antistats, water-repellants and impregnation agents, swelling and non-skid agents, non-aqueous solvents, rinse aids, protein hydrolyzates and UV-absorbers.

Bleaches and bleach activators are important constituents of washing and cleaning agents, and can be comprised in the inventive agents as well as other constituents. Among the compounds, which serve as bleaches and liberate H₂O₂ in water, sodium perborate tetrahydrate and sodium perborate monohydrate are of particular importance. Examples of further bleaches, which may be used, are percarbonate, peroxypyrophosphates, citrate perhydrates and H₂O₂-supplying peracidic salts or peracids, such as perbenzoates, peroxyphthalates, diperazelaic acid, phthaloiminoperacid or diperdodecanedioic acid. Washing or cleaning agent molded bodies for automatic dishwashers can also comprise bleaches from the group of organic bleaches. Typical organic bleaches are the diacyl peroxides, such as, for example, dibenzoyl peroxide. Further typical organic bleaches are the peroxy acids, particular examples being the alkylperoxy acids and the arylperoxy acids. Preferred representatives that can be used are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid [phthaloiminoperoxyhexanoic acid (PAP)], o-carboxybenzamido peroxycaproic acid, N-nonenylamidoperadipic acid and N-nonenylamido persuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyl-di(6-aminopercaproic acid).

When the inventive agents are used as automatic dishwasher agents, then they can comprise bleach activators in order to achieve an improved bleaching action on cleaning at temperatures of 60° C. and below. Bleach activators, which can be used are compounds which, under perhydrolysis conditions, produce aliphatic peroxycarboxylic acids having preferably 1 to 10 carbon atoms, in particular 2 to 4 carbon atoms, and/or optionally substituted perbenzoic acid. Substances, which carry O-acyl and/or N-acyl groups of said number of carbon atoms and/or optionally substituted benzoyl groups, are suitable. Preference is given to polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenolsulfonates, in particular n-nonanoyl- or isononanoyloxybenzenesulfonate (n- or iso-NOBS), carboxylic acid anhydrides, in particular phthalic anhydride, acylated polyhydric alcohols, in particular triacetin, ethylene glycol diacetate and 2,5-diacetoxy-2,5-dihydrofuran.

In the context of the present application, further preferred added bleach activators are compounds from the group of cationic nitriles, particularly cationic nitriles of the Formula 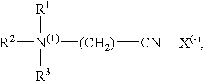
in which R¹ stands for —H, —CH₃, a C₂₋₂₄ alkyl or alkenyl radical, a substituted C₂₋₂₄ alkyl or alkenyl radical having at least one substituent from the group of —Cl, —Br, —OH, —NH₂, —CN, an alkyl or alkenylaryl radical having a C₁₋₂₄ alkyl group or for an alkyl or alkenylaryl radical having a C₁₋₂₄ alkyl group and at least a further substituent on the aromatic ring, R² and R³, independently of one another are selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH with n=1, 2, 3, 4, 5 or 6 and X is an anion.

In particularly preferred agents according to the invention, there is a cationic nitrile of the Formula 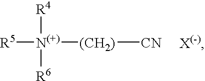
comprised, in which R⁴, R⁵ and R⁶ independently of one another are selected from —CH₃, —CH₂—CH₃, —CH₂—CH₂—CH₃, —CH(CH₃)—CH₃, wherein R⁴ can also be —H and X is an anion, wherein preferably R⁵=R⁶=—CH₃ and particularly R⁴=R⁵=R⁶=—CH₃, and compounds of the formulae (CH₃)₃N⁽⁺⁾CH₂—CN X⁻, (CH₃CH₂)₃N⁽⁺⁾CH₂—CN X⁻, (CH₃CH₂CH₂)₃N⁽⁺⁾CH₂—CN X⁻, (CH₃CHCH₃)₃N⁽⁺⁾CH₂—CN X⁻ or (OHCH₂CH₂)₃N⁽⁺⁾CH₂—CN X⁻ are particularly preferred, wherein from the group of these substances, the cationic nitrile of formula (CH₃)₃N⁽⁺⁾CH₂—CN X⁻ is particularly preferred, in which X⁻ stands for an anion that is selected from the group chloride, bromide, iodide, hydrogen sulfate, methosulfate, p-toluene sulfate (tosylate) or xylene sulfonate.

In addition to the conventional bleach activators, or instead of them, so-called bleach catalysts may also be incorporated into the inventive agents. These substances are bleach-boosting transition metal salts or transition metal complexes, such as for example, Mn-, Fe-, Co-, Ru- or Mo-salen complexes or -carbonyl complexes. Mn—, Fe-, Co-, Ru-, Mo-, Ti-, V- and Cu-complexes with N-containing tripod ligands, and Co-, Fe-, Cu- and Ru-ammine complexes can also be used as bleach catalysts.

As surfactants, anionic surfactants in acid form, aqueous solutions or pastes of neutralized anionic surfactant acids, nonionic surfactants and/or cationic surfactants or amphoteric surfactants are particularly considered. Depending on the choice of the added surfactant(s), surfactant-comprising inventive agents are used for example to eliminate fat and oil stains, their field of application ranging from textile cleaning to eliminating oil stains in nature. In the context of the present application, granules are preferred, which have a surfactant content of 1 to 70 wt. %, preferably 2 to 60 wt. %, particularly preferably 2 to 50 wt. %, each based on the total weight of the agent.

In addition to the cited ingredients, bleaches and bleach activators, builders are important ingredients of washing and cleaning agents. Preferred inventive agents may contain any of the builders typically used in detergents, i.e. in particular, silicates, carbonates, organic co builders and also—where there are no ecological reasons preventing their use—phosphates. Naturally, in this context, the cited builders can also be used in surfactant-free tablets.

Suitable crystalline, layered sodium silicates correspond to the general formula NaMSiₓO2ₓ₊₁.H₂O, wherein M is sodium or hydrogen, x is a number from 1.9 to 4 and y is a number from 0 to 20, preferred values for x being 2, 3 or 4. Preferred crystalline, layered silicates of the given formula are those in which M stands for sodium and x assumes the values 2 or 3.

Both β- and δ-sodium disilicates Na₂Si₂O₅.yH₂O are particularly preferred.

Other useful builders are amorphous sodium silicates with a modulus (Na₂O:SiO₂ ratio) of 1:2 to 1:3.3, preferably 1:2 to 1:2.8 and more preferably 1:2 to 1:2.6, which dissolve with a delay and exhibit multiple wash cycle properties. The delay in dissolution compared with conventional amorphous sodium silicates can have been obtained in various ways, for example by surface treatment, compounding, compressing/compacting or by over-drying. In the context of the invention, the term “amorphous” is also understood to encompass “X-ray amorphous”. In other words, the silicates do not produce any of the sharp X-ray reflexes typical of crystalline substances in X-ray diffraction experiments, but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This can be interpreted to mean that the products have microcrystalline regions between 10 and a few hundred nm in size, values of up to at most 50 nm and especially up to at most 20 nm being preferred. This type of X-ray amorphous silicates similarly possesses a delayed dissolution in comparison with the customary water glasses. Compacted/densified amorphous silicates, compounded amorphous silicates and over dried X-ray-amorphous silicates are particularly preferred.

Of the suitable fine crystalline, synthetic zeolites containing bound water, zeolite A and/or P are preferred. A particularly preferred zeolite P is zeolite MAP® (a commercial product of Crosfield). However, the zeolites X as well as mixtures of A, X and/or P are also suitable. Commercially available and preferred in the context of the present invention is, for example, also a co-crystallizate of zeolite X and zeolite A (ca. 80 wt. % zeolite X), which is marketed under the name of VEGOBOND AX® by Condea Augusta S.p.A. and which can be described by the Formula
nNa₂O.(1-n)K₂O.Al₂O₃.(2-2.5)SiO₂.(3.5-5.5)H₂O

Suitable zeolites have a mean particle size of less than 10 μm (volume distribution, as measured by the Coulter Counter Method) and contain preferably 18 to 22% by weight and more preferably 20 to 22% by weight of bound water.

Naturally, the generally known phosphates can also be added as builders, in so far that their use should not be avoided on ecological grounds.

The sodium salts of the orthophosphates, the pyrophosphates and especially the tripolyphosphates are particularly suitable.

“Alkali metal phosphates” is the collective term for the alkali metal (more particularly sodium and potassium) salts of the various phosphoric acids, including metaphosphoric acids (HPO₃)ₙ and orthophosphoric acid (H₃PO₄) and representatives of higher molecular weight. The phosphates combine several advantages: they act as alkalinity sources, prevent lime deposits on machine parts and lime incrustations in fabrics and, in addition, contribute towards the cleaning effect.

Sodium hydrogen phosphate, NaH₂PO₄, disodium hydrogen phosphate (secondary sodium phosphate), Na₂HPO₄, trisodium phosphate, tertiary sodium phosphate, Na₃PO₄, tetrasodium phosphate (sodium pyrophosphate) Na₄P2O₇ and by condensation of NaH₂PO₄ or the KH₂PO₄ to form higher molecular weight sodium and potassium phosphates, which may be divided into cyclic types, the sodium or potassium metaphosphates, and chain-forming types, the sodium or potassium polyphosphates, are also, like the pentasodium triphosphate Na₅P₃O₁₀ (sodium tripolyphosphate), advantageously used as builders in the context of the present application.

Useful organic builders are, for example, the polycarboxylic acids usable in the form of their alkaline and especially sodium salts, such as citric acid, adipic acid, succinic acid, glutaric acid, malic acid, tartaric acid, maleic acid, fumaric acid, sugar acids, aminocarboxylic acids, nitrilotriacetic acid (NTA), providing its use is not ecologically unsafe, and mixtures thereof. Preferred salts are the salts of polycarboxylic acids such as adipic acid, succinic acid, glutaric acid, tartaric acid, sugar acids and mixtures thereof.

Additional constituents can be alkaline entities. Alkali metal hydroxides, alkali metal carbonates, alkali metal hydrogen carbonates, alkali metal sesquicarbonates, alkali silicates, alkali metal silicates and mixtures of the cited materials can be used as alkaline entities, where in the context of this invention, the alkali carbonates are preferably used, especially sodium carbonate or sodium sesquicarbonate.

In the case that the inventive agent is used in automatic dishwashers, then water-soluble builders are preferred, as they generally tend to form less insoluble residues on tableware and hard surfaces. Typical builders are the low molecular weight polycarboxylic acids and their salts, the homopolymeric and copolymeric polycarboxylic acids and their salts, the carbonates, phosphates and silicates. Trisodium citrate and/or pentasodium tripolyphosphate and/or sodium carbonate and/or sodium bicarbonate and/or gluconates and/or silicate builders from the classes of the disilicates and/or metasilicates are preferably added for the manufacture of tablets for automatic dishwashers. A builder system comprising a mixture of tripolyphosphate and sodium carbonate is particularly preferred. A builder system comprising a mixture of tripolyphosphate and sodium carbonate and sodium disilicate is also particularly preferred.

Organic co builders, which may be used in the cleaning agents in the context of the present invention, include, in particular, polycarboxylates/polycarboxylic acids, polymeric polycarboxylates, aspartic acid, polyacetals, dextrins, other organic co builders (see below) and phosphonates. These classes of substances are described in the following.

Useful organic builders are, for example, the polycarboxylic acids usable in the form of their sodium salts, polycarboxylic acids in this context being understood to be carboxylic acids that carry more than one acid function. These include, for example, citric acid, adipic acid, succinic acid, glutaric acid, malic acid, tartaric acid, maleic acid, fumaric acid, sugar acids, aminocarboxylic acids, nitrilotriacetic acid (NTA), providing its use is not ecologically unsafe, and mixtures thereof. Preferred salts are the salts of the polycarboxylic acids, such as citric acid, adipic acid, succinic acid, glutaric acid, tartaric acid, methylglycinediacetic acid, sugar acids and mixtures thereof.

The acids per se may also be used. Besides their building effect, the acids also typically have the property of an acidifying component and, hence also serve to establish a relatively low and mild pH in detergents or cleaners. Citric acid, succinic acid, glutaric acid, adipic acid, gluconic acid and mixtures thereof are particularly mentioned in this regard.

Other suitable builders are polymeric polycarboxylates, i.e. for example the alkali metal salts of polyacrylic or polymethacrylic acid, for example those with a relative molecular weight of 500 to 70 000 g/mol.

The molecular weights mentioned in this specification for polymeric polycarboxylates are weight-average molecular weights M_{w} of the particular acid form which, fundamentally, were determined by gel permeation chromatography (GPC), equipped with a UV detector. The measurement was carried out against an external polyacrylic acid standard, which provides realistic molecular weight values by virtue of its structural similarity to the polymers investigated. These values differ distinctly from the molecular weights measured against polystyrene sulfonic acids as standard. The molecular weights measured against polystyrene sulfonic acids are generally higher than the molecular weights mentioned in this specification.

Particularly suitable polymers are polyacrylates, which preferably have a molecular weight of 1000 to 20 000 g/mol. By virtue of their superior solubility, preferred representatives of this group are again the short-chain polyacrylates, which have molecular weights of 1000 to 10 000 g/mol and, more particularly, 1200 to 4000 g/mol.

Both polyacrylates and also copolymers of unsaturated carboxylic acids, monomers containing sulfonic acid groups as well as optional additional ionic or nonionic monomers are particularly preferably used in the inventive agents. The copolymers containing sulfonic acid groups are described in detail below.

Inventive agents, known as “3 in 1” products can also be prepared, which combine customary cleaners, rinse agents and a salt replacement function.

In this context, inventive automatic dishwasher agents are preferred, which further comprise 0.1 to 70 wt. % copolymers of
i) unsaturated carboxylic acids,
ii) monomers containing sulfonic acid groups
iii) optional additional ionic or nonionic monomers.

These copolymers produce an additional positive effect, in that their use in hard water permits the tableware to be rinsed, i.e. no regeneration salt needs to be added up to a certain tap-water hardness, and be markedly cleaner than tableware that were washed with customary agents under these conditions. In the context of the present invention, unsaturated carboxylic acids of Formula I are preferred monomers,
R¹(R²)C═C(R³)COOH (I)
in which R¹ to R³ independently of one another stand for —H, —CH₃, a linear or branched, saturated alkyl radical containing 2 to 12 carbon atoms, a linear or branched, mono- or polyunsaturated alkenyl radical containing 2 to 12 carbon atoms, with —NH₂, —OH or —COOH substituted alkyl or alkenyl radicals as defined above or —COOH or —COOR⁴, wherein R⁴ is a saturated or unsaturated, linear or branched hydrocarbon radical containing 1 to 12 carbon atoms.

Among the unsaturated carboxylic acids corresponding to Formula I, acrylic acid (R¹=R²=R³=H), methacrylic acid (R¹=R²=H; R³=CH₃) and/or maleic acid (R¹=COOH; R²=R³=H) are particularly preferred.

Preferred monomers containing sulfonic acid groups correspond to Formula II,
R⁵(R⁶)C═C(R⁷)—X—SO₃H (II),
in which R⁵ to R⁷ independently of one another stand for —H, —CH₃, a linear or branched, saturated alkyl radical containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, where R⁴ is a saturated or unsaturated, linear or branched hydrocarbon radical containing 1 to 12 carbon atoms, and X stands for an optionally present spacer group chosen from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Among these monomers, those corresponding to Formulae IIa, IIb and/or IIc,
H₂C═CH—X—SO₃H (IIa),
H₂C═C(CH₃)—X—SO₃H (IIb),
HO₃S—X—(R⁶C═C(R⁷)—X—SO₃H (IIc),
in which R⁶ und R⁷ independently of one another are selected from —H, —CH₃, —CH₂CH₃, —CH₂CH₂CH₃, —CH(CH₃)₂ and X is an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Particularly preferred monomers containing sulfonic acid groups are 1-acrylamido-1-propanesulfonic acid (X=—C(O)NH—CH(CH₂CH₃) in formula (IIa)), 2-acrylamido-2-propanesulfonic acid (X=—C(O)NH—C(CH₃)₂ in formula (IIa)), 2-acrylamido-2-methyl-1-propanesulfonic acid (X=—C(O)NH—CH(CH₃)CH₂— in formula IIa)), 2-methacrylamido-2-methyl-1-propanesulfonic acid (X=—C(O)NH—H(CH₃)CH₂— in formula (IIb)), 3-methacrylamido-2-hydroxypropanesulfonic acid (X=—C(O)NH—CH₂OH(OH)CH₂— in formula (IIb)), allyl sulfonic acid (X=CH₂ in formula (IIa)), methallylsulfonic acid (X=CH₂ in formula (IIb)), allyloxybenzenesulfonic acid (X=—CH₂—O—C₆H₄— in formula (IIa)), methallyloxybenzenesulfonic acid (X=—CH₂—O—C₆H₄— in formula (IIb)), 2-hydroxy-3-(2-propenyloxy)-propanesulfonic acid, 2-methyl-2-propene-1-sulfonic acid (X=CH₂ in formula (IIb)), styrenesulfonic acid (X=C₆H₄ in formula (IIa)), vinylsulfonic acid (X not present in formula (IIa)), 3-sulfopropyl acrylate (X=—C(O)NH—CH₂CH₂CH₂— in formula (IIa)), 3-sulfopropyl methacrylate (X=—C(O)NH—CH₂CH₂CH₂— in formula (IIb)), sulfomethacrylamide (X=—C(O)NH— in formula (IIb)), sulfomethylmethacrylamide (X=—C(O)NH—CH₂— in formula (IIb)) and water-soluble salts of the acids mentioned.

Additional ionic or non-ionogenic monomers are particularly ethylenically unsaturated compounds. The polymers used in accordance with the invention preferably contain less than 20% by weight, based on polymer, of monomers belonging to group iii). Particularly preferred polymers for use consist solely of monomers belonging to groups i) and ii).

In summary, copolymers of
i) unsaturated carboxylic acids of Formula I.
   (R²)C═C(R³)COOH (I),
   in which R¹ to R³ independently of one another stand for —H, —CH₃, a linear or branched, saturated alkyl radical containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, where R⁴ is a saturated or unsaturated, linear or branched hydrocarbon radical containing 1 to 12 carbon atoms,
ii) monomers containing sulfonic acid groups corresponding to Formula II
   R⁵(R⁶)C═C(R⁷)—X—SO₃H (II),
   in which R⁵ to R⁷ independently of one another stand for —H, —CH₃, a linear or branched, saturated alkyl radical containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, where R⁴ is a saturated or unsaturated, linear or branched hydrocarbon radical containing 1 to 12 carbon atoms, and X is an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—.
iii) optionally additional ionic or nonionic monomers are particularly preferred.

Particularly preferred copolymers consist of
i) one or more unsaturated carboxylic acids from the group of acrylic acid, methacrylic acid and/or maleic acid
ii) one or more monomers containing sulfonic acid groups of Formulae IIa, IIb and/or IIc:
   H₂C═CH—X—SO₃H (IIa),
   H₂C═C(CH₃)—X—SO₃H (IIb),
   HO₃S—X—(R⁶)C═C(R⁷)—X—SO₃H (IIc),
   in which R⁶ und R⁷ independently of one another are selected from —H, —CH₃, —CH₂CH₃, —CH₂CH₂CH₃, —CH(CH₃)₂ and X is an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—
iii) optional additional ionic or nonionic monomers.

The copolymers contained in the agents can contain monomers from groups (i) and (ii) and optionally (iii) in varying amounts, wherein all representatives of group (i) can be combined with all representatives of group (ii) and all representatives of group (iii). Particularly preferred polymers have defined structural units, which are described below.

Thus, for example, preferred inventive agents are those wherein they comprise one or more copolymers that comprise structural units of Formula (III)
—[CH₂—CHCOOH]ₘ—[CH₂—CHC(O)—Y—SO₃H]ₚ— (III),
in which m and p are whole natural numbers between 1 to 2000 and Y is a spacer group selected from substituted or unsubstituted aliphatic, aromatic or araliphatic hydrocarbon radicals containing 1 to 24 carbon atoms, wherein spacer groups in which Y represents —O—(CH₂)ₙ— with n=0 to 4, —O—(C₆H₄)—, —NH—C(CH₃)₂— or —NH—CH(CH₂CH₃)— are preferred.

These polymers are produced by copolymerization of acrylic acid with an acrylic acid derivative containing sulfonic acid groups. If the acrylic acid derivative containing sulfonic acid groups is copolymerized with methacrylic acid, another polymer is obtained which can also be preferably incorporated in the inventive agent and which contains structural units corresponding to Formula IV
—[CH₂—C(CH₃)COOH]ₘ—[CH₂—CHC(O)—Y—SO₃H]ₚ— (IV),
in which m and p are whole natural numbers between 1 to 2000 and Y is a spacer group selected from substituted or unsubstituted aliphatic, aromatic or araliphatic hydrocarbon radicals containing 1 to 24 carbon atoms, wherein spacer groups in which Y represents —O(CH₂)ₙ— with n=0 to 4, for —O—(C₆H₄)—, for —NH—C(CH₃)₂— or —NH—CH(CH₂CH₃)— are preferred.

Entirely analogously, acrylic acid and/or methacrylic acid may also be copolymerized with methacrylic acid derivatives containing sulfonic acid groups, so that the structural units in the molecule are changed. Copolymers that contain structural units of Formula V
—[CH₂—CHCOOH]ₘ—[CH₂—C(CH₃)C(O)—Y—SO₃H]ₚ— (V),
in which m and p are whole natural numbers between 1 to 2,000 and Y is a spacer group selected from substituted or unsubstituted aliphatic, aromatic or araliphatic hydrocarbon radicals containing 1 to 24 carbon atoms, wherein spacer groups in which Y represents —O—(CH₂)ₙ— with n=0 to 4, —O—(C₆H₄)—, —NH—C(CH₃)₂— or —NH—CH(CH₂CH₃)— are preferably comprised in the inventive agents, exactly also like copolymers that contain structural units of Formula VI
—[CH₂—C(CH₃)COOH]ₘ—[CH₂—C(CH₃)C(O)—Y—SO₃H]ₚ— (VI),
in which m and p each stand for a whole natural number between 1 to 2,000 and Y is a spacer group selected from substituted or unsubstituted aliphatic, aromatic or araliphatic hydrocarbon radicals containing 1 to 24 carbon atoms, wherein spacer groups in which Y represents —O(CH₂)ₙ— with n=0 to 4, —O(C₆H₄)—, —NH—C(CH₃)₂— or —NH—CH(CH₂CH₃)— are preferred.

Maleic acid may also be used as a particularly preferred group i) monomer instead of or in addition to acrylic acid and/or methacrylic acid. In this way, it is possible to arrive at preferred agents according to the invention which are characterized in that they comprise one or more copolymers that contain structural units corresponding to formula (VII)
—[HOOCCH—CHCOOH]ₘ—[CH₂—CHC(O)—Y—SO₃H]ₚ— (VI),
in which m and p each stand for a whole natural number between 1 to 2000 and Y is a spacer group selected from substituted or unsubstituted aliphatic, aromatic or araliphatic hydrocarbon radicals containing 1 to 24 carbon atoms, wherein spacer groups in which Y represents —O—(CH₂)ₙ— with n=0 to 4, —O—(C₆H₄)—, —NH—C(CH₃)₂— or —NH—CH(CH₂CH₃)— are preferred, and to agents characterized in that they comprise one or more copolymers that contain structural units of Formula VIII
—[HOOCCH—CHCOOH]ₘ—[CH₂—C(CH₃)C(O)O—Y—SO₃H]ₚ— (VIII),
in which m and p are whole natural numbers between 1 to 2000 and Y is a spacer group selected from substituted or unsubstituted aliphatic, aromatic or araliphatic hydrocarbon radicals containing 1 to 24 carbon atoms, wherein spacer groups in which Y represents —O(CH₂)ₙ— with n=0 to 4, —O(C₆H₄)—, —NH—C(CH₃)₂— or —NH—CH(CH₂CH₃)— are preferred.

In summary, the preferred automatic dishwasher agents according to the invention comprise as ingredients b) one or more copolymers, which contain the structural units of Formula III and/or IV and/or V and/or VI and/or VII and/or VIII
—[CH₂—CHCOOH]ₘ—[CH₂CHC(O)—Y—SO₃H]ₚ— (III),
—[CH₂—C(CH₃)COOH]ₘ—[CH₂—CHC(O)—Y—SO₃H]ₚ— (IV)
—[CH₂—CHCOOH]ₘ—[CH₂—C(CH₃)C(O)—Y—SO₃H]ₚ (V).
—[CH₂—C(CH₃)COOH]ₘ—[CH₂—C(CH₃)C(O)—Y—SO₃H]ₚ— (VI),
—[HOOCCH—CHCOOH]ₘ—[CH₂—CHC(O)—Y—SO₃H]ₚ— (VII),
—[HOOCCH—CHCOOH]ₘ—[CH₂—C(CH₃)C(O)O—Y—SO₃H]ₚ— (VIII)
in which m and p each stand for a whole natural number between 1 to 2000 and Y is a spacer group selected from substituted or unsubstituted aliphatic, aromatic or araliphatic hydrocarbon radicals containing 1 to 24 carbon atoms, wherein spacer groups in which Y represents —O(CH₂)ₙ— with n=0 to 4, —O(C₆H₄)—, —NH—C(CH₃)₂— or —NH—CH(CH₂CH₃)— are preferred.

Maleic acid may also be used as a particularly preferred group i) monomer instead of or in addition to acrylic acid and/or methacrylic acid. In this way, it is possible to arrive at preferred agents according to the invention which are characterized in that they comprise one or more copolymers that contain structural units corresponding to formula (VII)
—[HOOCCH—CHCOOH]ₘ—[CH₂—CHC(O)—Y—SO₃H]ₚ— (VII),
in which m and p are whole natural numbers between 1 to 2000 and Y is a spacer group selected from substituted or unsubstituted aliphatic, aromatic or araliphatic hydrocarbon radicals containing 1 to 24 carbon atoms, wherein spacer groups in which Y represents —O(CH₂)ₙ— with n=0 to 4, —O(C₆H₄)—, —NH—C(CH₃)₂— or —NH—CH(CH₂CH₃)— are preferred, and to agents characterized in that they comprise one or more copolymers that contain structural units of Formula VIII
—[HOOCCH—CHCOOH]ₘ—[CH₂—C(CH₃)C(O)O—Y—SO₃H]ₚ— (VIII),
in which m and p are whole natural numbers between 1 to 2000 and Y is a spacer group selected from substituted or unsubstituted aliphatic, aromatic or araliphatic hydrocarbon radicals containing 1 to 24 carbon atoms, wherein spacer groups in which Y represents —O(CH₂)ₙ— with n=0 to 4, —O(C₆H₄)—, —NH—C(CH₃)₂— or —NH—CH(CH₂CH₃)— are preferred.

In summary, the preferred automatic dishwasher agents according to the invention comprise as ingredients b) one or more copolymers, which contain the structural units of Formula III and/or IV and/or V and/or VI and/or VII and/or VIII
—[CH₂—CHCOOH]ₘ—[CH₂CHC(O)—Y—SO₃H]ₚ— (III),
—[CH₂—C(CH₃)COOH]ₘ—[CH₂—CHC(O)—Y—SO₃H]ₚ— (IV),
—[CH₂CHCOOH]ₘ—[CH₂—C(CH₃)C(O)—Y—SO₃H]ₚ— (V),
—[CH₂—C(CH₃)COOH]ₘ—[CH₂—C(CH₃)C(O)—Y—SO₃H]ₚ— (VI),
—[HOOCCH—CHCOOH]ₘ—[CH₂—CHC(O)—Y—SO₃H]ₚ— (VII),
—[HOOCCH—CHCOOH]ₘ—[CH₂—C(CH₃)C(O)O—Y—SO₃H]ₚ— (VIII),
in which m and p each stand for a whole natural number between 1 to 2000 and Y is a spacer group selected from substituted or unsubstituted aliphatic, aromatic or araliphatic hydrocarbon radicals containing 1 to 24 carbon atoms, wherein spacer groups in which Y represents —O(CH₂)ₙ— with n=0 to 4, —O(C₆H₄)—, —NH—C(CH₃)₂— or —NH—CH(CH₂CH₃)— are preferred.

The sulfonic acid groups may be present in the polymers completely or partly in neutralized form, i.e. the acidic hydrogen atom of the sulfonic acid groups can be replaced by metal ions, preferably alkali metal ions and more particularly sodium ions, in some or all of the sulfonic acid groups. Corresponding agents, which are characterized in that the sulfonic acid groups in the copolymer are present in partly or fully neutralized form, are preferred according to the invention.

Generally speaking, for copolymers that comprise only monomers defined in groups (i) and (ii) of this document, the monomer distributions in the copolymers used in the inventive agents range from preferably 5 to 95 wt. % (i) and (ii) respectively, particularly preferably 50 to 90 wt. % monomer from group (i) and 10 to 50 wt. % monomer from group (ii) respectively, based on the polymer.

Particularly preferred terpolymers are those that comprise 20 to 85 wt. % monomer from group i), 10 to 60 wt. % monomer from group ii) and 5 to 30 wt. % monomer from group iii).

The molecular weight of the polymers used in the inventive agents can be varied to adapt the properties of the polymer to the desired application requirement. Preferred automatic dishwasher agents are characterized in that the copolymers have molecular weights from 2000 to 200 000 gmol⁻¹, preferably 4000 to 25 000 gmol⁻¹ and especially 5000 to 15 000 gmol⁻¹.

The content of one or more copolymers in the agents according to the invention can vary as a function of the application and desired product performance, wherein preferred inventive automatic dishwasher agents are characterized in that they comprise the copolymer(s) in quantities from 0.25 to 50 wt. %, preferably from 0.5 to 35 wt. %, particularly preferably from 0.75 to 20 wt. % and especially from 1 to 15 wt. %.

As already described above, both polyacrylates and also the abovementioned copolymers of unsaturated carboxylic acids, monomers containing sulfonic acid groups as well as optional additional ionic or nonionic monomers are particularly preferably used in the inventive agents. In this context, the polyacrylates were described in detail above. Combinations of the previously described sulfonic acid group-containing copolymers with polyacrylates of low molecular weight, for example between 1000 and 4000 daltons, are particularly preferred. Such polyacrylates are commercially available under the trade name Sokalan® PA15 or Sokalan® PA25 (BASF).

Further suitable copolymeric polycarboxylates are particularly those of acrylic acid with methacrylic acid and of acrylic acid or methacrylic acid with maleic acid. Copolymers of acrylic acid with maleic acid, which comprise 50 to 90 wt. % acrylic acid and 50 to 10 wt. % maleic acid, have proven to be particularly suitable. Their relative molecular weight, based on free acids, generally ranges from 2000 to 100 000 g/mol, preferably 20 000 to 90 000 g/mol and especially 30 000 to 80 000 g/mol.

The (co)polymeric polycarboxylates can be used either as powders or as aqueous solutions. The (co)polymeric polycarboxylate content of the compositions is preferably from 0.5 to 20% by weight, in particular from 3 to 10% by weight.

In order to improve the water solubility, the polymers can also comprise allylsulfonic acids as monomers, such as for example, allyloxybenzenesulfonic acid and methallylsulfonic acid

Particular preference is also given to biodegradable polymers comprising more than two different monomer units, examples being those comprising, as monomers, salts of acrylic acid and of maleic acid, and also vinyl alcohol or vinyl alcohol derivatives, or those comprising, as monomers, salts of acrylic acid and of 2-alkylallylsulfonic acid, and also sugar derivatives.

Preferably, one or more substances from the group of carboxylic acids, half esters of sulfuric acid and sulfonic acids, preferably from the group of fatty acids, the fatty alkyl sulfuric acids and the alkylaryl sulfonic acids are used as the acid form of anionic surfactants. In order to possess adequate surface-active properties, the cited compounds should consequently incorporate longer chain hydrocarbon radicals, i.e. there should be at least 6 carbon atoms in the alkyl or alkenyl radicals. Normally, the carbon chain distributions of the anionic surfactants are between 6 and 40, preferably 8 and 30 and especially between 12 and 22 carbon atoms.

Carboxylic acids, which find use in the form of their alkali metal salts in washing and cleaning products, are for the most part obtained industrially from natural fats and oils by hydrolysis. While the alkaline saponification process, already used in the previous century, afforded the alkali salts (soaps), today, industrially, only water is used to cleave the fats into glycerin and free fatty acids. Industrially practiced processes are e.g. cleavage in autoclaves or continuous high-pressure cleavage. In the context of the present invention, suitable carboxylic acids as the acid form of anionic surfactants are, for example, hexanoic acid (capronic acid), heptanoic acid (enanthic acid), octanoic acid (caprylic acid), nonanoic acid (pelargonic acid), decanoic acid (caprinic acid), undecanoic acid etc. In the context of the present invention, preferred fatty acids are dodecanoic acid (laurinic acid), tetradecanoic acid (myristinic acid), hexadecanoic acid (palmitinic acid), octadecanoic acid (stearinic acid), eicosanoic acid (arachinic acid), docosanoic acid (behenic acid), tetracosanoic acid (lignocerinic acid), hexacosanoic acid (cerotinic acid), triacotanoic acid (melissinic acid) as well as the unsaturated series 9c-hexadecenoic acid (palmitoleinic acid), 6c-octadecenoic acid (petroselinic acid), 6t-octadecenoic acid (petroselaidinic acid), 9c-octadecenoic acid (olic acid), 9t-octadecenoic acid (elaidinic acid), 9c,12c-octadecadienoic acid (linolic acid), 9t,12t-octadecadienoic acid (linolaidinic acid) und 9c,12c,15c-octadecatrienoic acid (linolenic acid). For reasons of cost, it is preferred not to use the pure species but rather technical mixtures of the individual acids, just as they are obtained by fat cleavage. Such mixtures are, for example coconut oil fatty acid (about 6% by weight C8, 6% by weight C10, 48% by weight C12, 18% by weight C14, 10% by weight C16, 2% by weight C18, 8% by weight C18′, 1% by weight C18″), palm kernel oil fatty acid (about 4% by weight C8, 5% by weight C10, 50% by weight C12, 15% by weight C14, 7% by weight C16, 2% by weight C18, 15% by weight C18′, 1% by weight C18″), tallow fatty acid (about 3% by weight C14, 26% by weight C16, 2% by weight C16′, 2% by weight C17, 17% by weight C18, 44% by weight C18′, 3% by weight C18″, 1% by weight C18′″), hydrogenated tallow fatty acid (about 2% by weight C14, 28% by weight C16, 2% by weight C17, 63% by weight C18, 1% by weight C18′), technical-grade oleic acid (about 1% by weight C12, 3% by weight C14, 5% by weight C16, 6% by weight C16′, 1% by weight C17, 2% by weight C18, 70% by weight C18′, 10% by weight C18″, 0.5% by weight C18′″), technical-grade palmitic/stearic acid (about 1% by weight C12, 2% by weight C14, 45% by weight C16, 2% by weight C17, 47% by weight C18, 1% by weight C18′), and soybean oil fatty acid (about 2% by weight C14, 15% by weight C16, 5% by weight C18, 25% by weight C18′, 45% by weight C18″, 7% by weight C1 8 ′″).

Sulfuric acid half esters of longer chain alcohols are also anionic surfactants in their acid form and are suitable in the context of the present invention. Their alkali metal salts, particularly sodium salts, the fatty alcohol sulfates are obtained industrially from fatty alcohols, which are reacted with sulfuric acid, chlorosulfonic acid, amidosulfonic acid or sulfur trioxide to afford the corresponding alkylsulfuric acids and subsequently neutralized. The fatty alcohols are thus obtained from the corresponding fatty acids or fatty acid mixtures by high pressure hydrogenation of the fatty acid methyl esters. The quantitatively most important industrial process for the manufacture of fatty alkyl sulfuric acids is the sulfonation of the alcohols with SO₃/air mixtures in special cascade, falling film or multi-tube reactors.

A further class of anionic surfactant acids, which can be used according to the invention, are the alkyl ether sulfuric acids, their salts, the alkyl ether sulfates, which in comparison to the alkyl sulfates possess a higher water solubility and are less sensitive towards hard water (solubility of the Ca salts). Alkyl ether sulfur acids are synthesized, like the alkyl sulfur acids, from fatty alcohols, which are reacted with ethylene oxide to afford the corresponding fatty alcohol ethoxylates. Propylene oxide can also be used instead of ethylene oxide. The subsequent sulfonation with gaseous sulfur trioxide in short-time sulfonation reactors affords yields of over 98% of the corresponding alkyl ether sulfur acids.

Alkane sulfonic acids and olefinsulfonic acids can be used as anionic surfactants in the context of the present invention. Alkanesulfonic acids can contain a terminal sulfonic acid group (primary alkanesulfonic acids) or one along the carbon chain (secondary alkanesulfonic acids), wherein only the secondary alkanesulfonic acids have commercial importance. They are manufactured by sulfochlorination or sulfoxidation of linear hydrocarbons. For sulfochlorination according to Reed, n-paraffins are converted with sulfur trioxide and chlorine under UV-irradiation to the corresponding sulfochlorides, which directly afford the alkanesulfonates by hydrolysis with alkalis and alkanesulfonic acids by hydrolysis with water. As the by-products from the radical reactions—di and polysulfochlorides as well as chlorinated hydrocarbons—can result from the sulfochlorination, the reaction is normally carried out with conversions of 30% and then terminated.

Another manufacturing process for alkanesulfonic acids is the sulfoxidation, where n-paraffins are reacted with sulfur trioxide and oxygen under UV-irradiation. This radical reaction affords successive alkylsulfonyl radicals, which further react with oxygen to yield alkylpersulfonyl radicals. The reaction with unreacted paraffin affords an alkyl radical and the alkylpersulfonic acid, which decomposes into an alkylperoxysulfonyl radical and a hydroxyl radical. The reaction of both the radicals with unreacted paraffin affords the alkylsulfonic acids and water, which reacts with alkylpersulfonic acid and sulfur trioxide to sulfuric acid. In order to maintain the highest possible yield of both the end products alkylsulfonic acid and sulfuric acid, and to suppress side reactions, this reaction is normally run with conversion rates of up to 1% and then interrupted.

Olefinsulfonates are manufactured industrially by the reaction of α-olefins with sulfur trioxide. They form zwitterions, which cyclize to so-called sultones. Under suitable conditions (alkaline or acid hydrolysis), these sultones react to form hydroxyalkanesulfonic acids or alkenesulfonic acids, both of which can also be used as anionic surfactant acids.

Alkylbenzenesulfonates have been known since the thirties of this century as powerful anionic surfactants. At that time, alkylbenzenes were manufactured by monochlorinating Kogasin fractions and subsequent Friedel-Crafts alkylation and were sulfonated with oleum and neutralized with sodium hydroxide. For the manufacture of alkylbenzenesulfonates at the beginning of the fifties, propylene was tetramerized to branched α-dodecene and the product was converted with aluminum trichloride or hydrogen fluoride, using a Friedel-Crafts reaction, to tetrapropylbenzene that was subsequently sulfonated and neutralized. This economic possibility for manufacturing tetrapropylbenzenesulfonic acid (TPS) led to a breakthrough of this class of surfactant, which subsequently displaced the soaps as the major surfactant in laundry and cleaning products.

The inadequate biodegradability of TPS necessitated the synthesis of new alkylbenzenesulfonates, which possess an improved ecological behavior. These requirements were fulfilled by linear alkylbenzenesulfonates, which are almost the sole alkylbenzenesulfonates manufactured today and are abbreviated to ABS or LAS.

Linear alkylbenzenesulfonates are manufactured from alkylbenzenes, which are again obtained from linear olefins. For this, commercial petroleum fractions are separated into the n-paraffins using molecular sieves and dehydrogenated to the n-olefins, resulting in both α- as well as i-olefins. The resulting olefins, in the presence of acid catalysts and benzene, are then converted into the alkylbenzenes, wherein the choice of Friedel-Crafts catalyst has an influence on the isomer distribution of the resulting linear alkylbenzenes. By using aluminum trichloride, the content of the 2-phenyl isomers in the mixture with the 3-, 4-, 5- and other isomers, is ca. 30 wt. %; in contrast, when hydrogen fluoride is used as the catalyst, the content of 2-phenyl isomer sinks below ca. 20 wt. %. Finally, today's commercial sulfonation of linear alkylbenzenes is with oleum, sulfuric acid or gaseous sulfur trioxide, the last being by far the most important. Special film or multi-tube reactors are used for sulfonation, yielding a 97% pure alkylbenzenesulfonic acid product (ABSS), which can be used as the anionic surfactant acid in the context of the present invention.

The most varied salts, i.e. alkylbenzene sulfonates, can be obtained from the ABSS by choosing the neutralizing agent. On economic grounds, it is preferred here to manufacture and use the alkali metal salts and among them, preferably the sodium salts of the ABSS. These can be described by means of the general Formula IX: 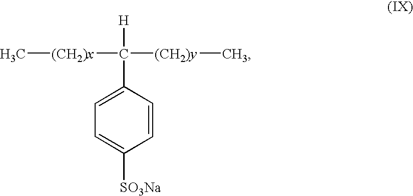
in which the sum of x and y normally lies between 5 and 13. According to the invention, preferred anionic surfactants in acid form are C₈₋₁₆, preferably C₉₋₁₃ alkylbenzenesulfonic acids. It is further preferred in the context of the present invention to use C₈₋₁₆, preferably C₉₋₁₃-alkylbenzenesulfonic acids, which derive from alkylbenzenes that have a tetralin content below 5 wt. %, based on the alkylbenzene. It is additionally preferred to use alkylbenzenesulfonic acids, whose alkylbenzenes were manufactured by the HF-process, such that the added C₈₋₁₆- preferably C₉₋₁₃-alkylbenzenesulfonic acids have a content of 2-phenyl isomer below 22 wt. %, based on the alkylbenzenesulfonic acid.

The abovementioned anionic surfactants in their acid form can be used alone or in mixtures with one another. However, it is also possible and preferred that before the addition to the carrier material(s), additional, preferably acid ingredients of washing and cleaning products be mixed with the anionic surfactant in acid form in quantities of 0.1 to 40 wt. %, preferably from 1 to 15 wt. % and especially from 2 to 10 wt. %, each based on the weight of the mixture to be reacted.

Beside the “surfactant acids”, the cited fatty acids, phosphonic acids, polymer acids or partially neutralized polymer acids as well as “builder acids” and “complex builder acids” (details later in the text) individually as well as in any mixtures are also suitable liquid binding agents in the context of the present invention. Suitable detergent ingredients, which may be added to the anionic surfactant acid before foaming, are above all acidic detergent ingredients, i.e. for example phosphonic acids, which in neutralized form (phosphonates) are present as incrustation inhibitors in many detergents. Also, the addition of (partially neutralized) polymer acids, such as for example polyacrylic acids, is possible according to the invention. However, it is also possible to blend acid-stable ingredients with the anionic surfactant acid. Here, minor components should be considered, which otherwise would have to be added in costly, additional steps, i.e. optical brighteners, dyes etc., wherein the acid stability needs to be tested in specific cases.

It is also possible, of course, to add the anionic surfactant in partially or fully neutralized form. These salts can then be present in the granulation liquid as a solution, suspension or emulsion, but also as a component of the solid bed. Apart from the alkali metals (here particularly according to demands and K-salts), the cations for such anionic surfactants can be ammonium- as well as mono-, di- or triethanolalkonium-ions Instead of mono-, di- or triethanolamine, the analogous members of mono-, di- or trimethanolamine or such alkanolamines of higher alcohols can be quaternized and used as cations.

Cationic surfactants can also be advantageously used as active substances. The cationic surfactant can be added directly as delivered into the mixer, or be sprayed, in the form of a liquid to pasty cationic surfactant preparation, onto the solid carrier material. Such cationic surfactant preparations can be prepared, for example, by mixing commercial cationic surfactants with auxiliaries such as nonionic surfactants, polyethylene glycols or polyols. Also, lower alcohols, such as ethanol and isopropanol, can be added, wherein the amount of such lower alcohols in the liquid cationic surfactant preparation should be, on the abovementioned grounds, under 10 wt. %.

All customary materials can be considered as cationic surfactants for the inventive agent, cationic surfactants having a textile-softening effect being markedly preferred.

The inventive agents can comprise one or more cationic, textile-softening agents of Formulae X, XI or XII as cationic active substances having a textile-softening effect: 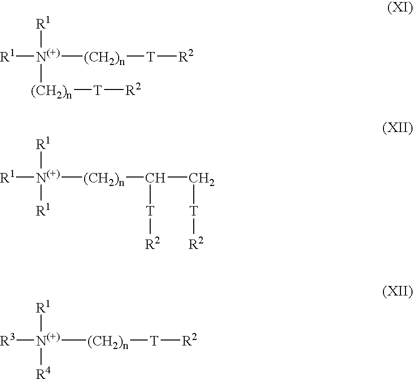
in which each group R¹, independently of one another, is chosen from C₁₋₆-alkyl, -alkenyl or -hydroxyalkyl groups; each group R², independently of one another, is chosen from C₈₋₂₈-alkyl or -alkenyl groups; R³=R¹ or (CH₂)ₙ-T-R²; R⁴=R¹ or R² or (CH₂)ₙ-T-R²; T=—CH₂—, —O—CO— or —CO—O— and n is an integer from 0 to 5.

In preferred embodiments of the present invention, the solid(s) comprise(s) additional nonionic surfactant(s) as the active substance.

Preferred nonionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol radical may be linear or, preferably, methyl-branched in the 2-position or may contain linear and methyl-branched radicals in the form of the mixtures typically present in oxoalcohol radicals. Particularly preferred are, however, alcohol ethoxylates with linear radicals of alcohols of natural origin with 12 to 18 carbon atoms, e.g. from coco-, palm-, tallow- or oleyl alcohol, and an average of 2 to 8 EO per mol alcohol. Exemplary ethoxylated alcohols include C₁₂₋₁₄-alcohols with 3 EO or 4 EO, C₉₋₁₁-alcohols with 7 EO, C₁₃₋₁₅-alcohols with 3 EO, 5 EO, 7 EO or 8 EO, C₁₂₋₁₈-alcohols with 3 EO, 5 EO or 7 EO and mixtures thereof, such as mixtures of C₁₂₋₁₄-alcohols with 3 EO and C₁₂₋₁₈— alcohols with 5 EO. The cited carbon chain lengths and the degree of alkoxylation again constitute statistical average values that can be a whole or a fractional number for a specific product. Preferred alcohol ethoxylates have a narrowed homolog distribution (narrow range ethoxylates, NRE). In addition to these nonionic surfactants, fatty alcohols with more than 12 EO can also be used. Examples of these are tallow fatty alcohol with 14 EO, 25 EO, 30 EO or 40 EO.

Particularly preferred nonionic surfactants in the context of the present invention have proved to be weakly foaming non-ionic surfactants, which have alternating ethylene oxide and alkylene oxide units. Among these, the surfactants with EO-AO-EO-AO blocks are again preferred, wherein one to ten EO or AO groups respectively are linked together, before a block of the other groups follows. Inventive agents are preferred here, which comprise surfactants of the general formula XIV as the nonionic surfactant(s) 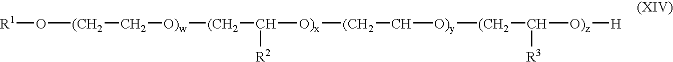
in which R¹ stands for a linear or branched, saturated or mono- or polyunsaturated C₆₋₂₄-alkyl or alkenyl radical, each group R² or R³ independently of one another is selected from —CH₃, —CH₂CH₃, —CH₂CH₂—CH₃, —CH(CH₃)₂, and the indices w, x, y, z stand for whole numbers between 1 and 6.

Preferred surfactants of Formula XIV can be prepared by known methods from the corresponding alcohols R¹—OH and ethylene- or alkylene oxide. The radical R¹ in the above formula XIV can vary according to the origin of the alcohol. If natural sources are used, the radical R1 has an even number of carbon atoms and is normally not branched, the linear radicals of alcohols from natural origin with 12-18 carbon atoms, e.g. coconut, palm, tallow fat or oleyl alcohol being preferred. Alcohols obtainable by synthesis are for example Guerbet alcohols or mixtures of linear or methyl branched (in the 2-position) radicals, as normally found in oxo alcohol radicals. Independently of the type of manufacture of the alcohols used in the nonionic surfactants that are comprised in the inventive agent, preferred inventive agents are those in which R¹ in Formula XIV stands for an alkyl radical having 6 to 24, preferably 8 to 20, particularly preferably 9 to 15 and especially 9 to 11 carbon atoms.

The alkylene oxide unit, which alternates with the ethylene oxide unit comprised in preferred nonionic surfactants, is, beside propylene oxide, particularly butylene oxide. However, other alkylene oxides, in which R² or R³ independently of one another are selected from —CH₂CH₂—CH₃ or CH(CH₃)₂ are suitable. Preferred agents are characterized in that R² or R³ stand for a —CH₃ radical, w and x independently of one another stand for values of 3 or 4 and y and z independently of one another stand for values of 1 or 2.

In summary, particularly nonionic surfactants, which have a C₉₋₁₅ alkyl radical with 1 to 4 ethylene oxide units, followed by 1 to 4 propylene oxide units, followed by 1 to 4 ethylene oxide units, followed by 1 to 4 propylene oxide units are preferred to be added to the inventive agents.

The given carbon chain lengths and the degrees of ethoxylation or alkoxylation represent statistical average values, which can be a whole or a fractional number for a specific product. Due to the manufacturing process, commercial products of the cited formulae mostly consist of not one individual member, but rather as mixtures, whereby both the carbon chain length, as well as the degrees of ethoxylation or alkoxylation, are average values and in consequence can take fractional numbers.

Other suitable non-ionic surfactants are alkyl glycosides with the general formula RO(G)x where R is a primary, linear or methyl-branched, more particularly 2-methyl-branched, aliphatic radical containing 8 to 22 and preferably 12 to 18 carbon atoms and G stands for a glycose unit containing 5 or 6 carbon atoms, preferably glucose. The degree of oligomerization x, which indicates the distribution of monoglycosides and oligoglycosides, is a number between 1 and 10 and preferably 1.2 to 1.4.

Another class of preferred non-ionic surfactants which may be used, either as the sole non-ionic surfactant or in combination with other non-ionic surfactants are alkoxylated, preferably ethoxylated or ethoxylated and propoxylated, fatty acid alkyl esters, preferably containing 1 to 4 carbon atoms in the alkyl chain, more especially fatty acid methyl esters.

Non-ionic surfactants of the amine oxide type, for example N-coconutalkyl-N,N-dimethylamine oxide and N-tallowalkyl-N,N-dihydroxy-ethylamine oxide, and the fatty acid alkanolamide type are also suitable. The quantity in which these non-ionic surfactants are used is preferably no more than the quantity in which the ethoxylated fatty alcohols are used and, more preferably, no more than half that quantity.

Other suitable surfactants are polyhydroxyfatty acid amides corresponding to formula (XV), 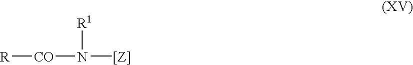
in which RCO is an aliphatic acyl group containing 6 to 22 carbon atoms, R¹ is hydrogen, an alkyl or hydroxyalkyl radical containing 1 to 4 carbon atoms and [Z] is a linear or branched polyhydroxyalkyl group containing 3 to 10 carbon atoms and 3 to 10 hydroxyl groups. The polyhydroxy fatty acid amides are known substances, which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxy fatty acid amides also includes compounds corresponding to formula (XVI), 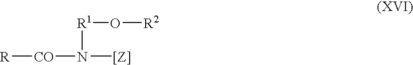
in which R is a linear or branched alkyl or alkenyl radical containing 7 to 12 carbon atoms, R¹ is a linear, branched or cyclic alkyl radical or an aryl radical containing 2 to 8 carbon atoms and R² is a linear, branched or cyclic alkyl radical or an aryl radical or an oxyalkyl radical containing 1 to 8 carbon atoms, C₁₋₄ alkyl or phenyl radicals being preferred, and [Z] is a linear polyhydroxyalkyl radical, of which the alkyl chain is substituted by at least two hydroxyl radicals, or alkoxylated, preferably ethoxylated or propoxylated derivatives of that radical.

[Z] is preferably obtained by reductive amination of a reducing sugar, for example glucose, fructose, maltose, lactose, galactose, mannose or xylose. The N-alkoxy- or N-aryloxy substituted compounds may then be converted into the required polyhydroxy fatty acid amides by reaction with fatty acid methyl esters in the presence of an alkoxide as catalyst.

For many applications, it is particularly preferred if the ratio of anionic surfactant(s) to nonionic surfactant(s) lies between 10:1 and 1:10, particularly between 7.5:1 and 1:5 and especially between 5:1 and 1:2. Thus, preferred inventive containers comprise the surfactant(s), preferably anionic and/or nonionic surfactants in quantities of 5 to 80 wt. %, preferably 7.5 to 70 wt. %, particularly preferably 10 to 60 wt. % and especially 12.5 to 50 wt. %, each based on the weight of the enclosed solids.

As already mentioned, the addition of surfactants in detergents for automatic dishwashers is preferably limited to the addition of small amounts of nonionic surfactants. Should the inventive containers include such materials, then the agents preferably comprise only specific nonionic surfactants, which are described below. Normally, only weakly foaming nonionic surfactants are added in automatic dishwasher agents as surfactants. In contrast, representatives of the groups of anionic, cationic or amphoteric surfactants have a limited importance. As nonionic surfactants, preferably alkoxylated, advantageously ethoxylated, particularly primary alcohols with preferably 8 to 18 carbon atoms and on average 1 to 12 mole ethylene oxide (EO) per mole alcohol, are added, in which the alcohol radical can be linear or preferably methyl branched in the 2-position or can comprise a mixture of linear or methyl branched (in the 2-position) radicals, as normally found in oxo alcohol radicals. However, alcohol ethoxylates with linear radicals from alcohols of natural origin with 12-18 carbon atoms, e.g. coconut, palm, tallow fat or oleyl alcohol, and on average 2 to 8 EO per mole alcohol are particularly preferred. Preferred ethoxylated alcohols include, for example, C₁₂₋₁₄ alcohols containing 3 EO or 4 EO, C₉₋₁₁ alcohol containing 7 EO, C₁₃₋₁₅ alcohols containing 3 EO, 5 EO, 7 EO or 8 EO, C₁₂₋₁₈ alcohols containing 3 EO, 5 EO or 7 EO and mixtures thereof, such as mixtures of C₁₂₋₁₄ alcohol containing 3 EO and C₁₂₋₁₈ alcohol containing 5 EO. The degrees of ethoxylation mentioned represent statistical mean values, which for a special product, can be a whole number or a fractional number. Preferred alcohol ethoxylates have a narrow homolog distribution (narrow range ethoxylates, NRE). In addition to these non-ionic surfactants, fatty alcohols containing more than 12 EO may also be used, examples including tallow fatty alcohol containing 14 EO, 25 EO, 30 EO or 40 EO.

Particularly for inventive water-soluble containers for the portioning, packaging and dosing of detergents for automatic dishwashers, it is preferred if they comprise a nonionic surfactant that exhibits a melting point above room temperature, preferably a nonionic surfactant with a melting point above 20° C. Preferred, suitable nonionic surfactants have melting points above 25° C., particularly preferred, suitable nonionic surfactants have melting points between 25 and 60° C. and, especially between 26.6 and 43.3° C.

Suitable non-ionic surfactants with melting or softening points in the temperature range mentioned above are, for example, low-foaming, non-ionic surfactants which may be solid or highly viscous at room temperature. If non-ionic surfactants are used that are highly viscous at room temperature, they preferably have a viscosity above 20 Pas, particularly preferably above 35 Pas and especially above 40 Pas. Non-ionic surfactants, which are wax-like in consistency at room temperature, are also preferred.

Non-ionic surfactants solid at room temperature preferably used in accordance with the invention belong to the groups of alkoxylated non-ionic surfactants, more particularly ethoxylated primary alcohols, and mixtures of these surfactants with structurally complex surfactants, such as polyoxypropylene/polyoxyethylene/polyoxypropylene (PO/EO/PO) surfactants. In addition, (PO/EO/PO) non-ionic surfactants are distinguished by good foam control.

In a preferred embodiment of the present invention, the non-ionic surfactant with a melting point above room temperature is an ethoxylated nonionic surfactant that results from the reaction of a monohydroxyalkanol or alkylphenol containing 6 to 20 carbon atoms with preferably at least 12 moles, particularly preferably at least 15 moles and especially at least 20 moles of ethylene oxide per mole of alcohol or alkylphenol.

A particularly preferred nonionic surfactant that is solid at room temperature is obtained from a straight-chain fatty alcohol containing 16 to 20 carbon atoms (C₁₆₋₂₀ alcohol), preferably a C₁₋₈ alcohol, and at least 12 moles, preferably at least 15 moles and more preferably at least 20 moles of ethylene oxide. Of these non-ionic surfactants, the so-called narrow range ethoxylates (see above) are particularly preferred.

The non-ionic surfactant that is solid at room temperature preferably also contains propylene oxide units in the molecule. These PO units preferably make up as much as 25% by weight, more preferably as much as 20% by weight and, especially up to 15% by weight of the total molecular weight of the nonionic surfactant. Automatic dishwasher agents containing ethoxylated and propoxylated non-ionic surfactants where the propylene oxide units in the molecule make up as much as 25% by weight, preferably 20% by weight and especially 15% by weight of the total molecular weight of the nonionic surfactant are preferred embodiments of the present invention. Particularly preferred nonionic surfactants are ethoxylated monohydroxyalkanols or alkylphenols, which additionally contain polyoxyethylene/polyoxypropylene block copolymer units. The alcohol or alkylphenol component of these non-ionic surfactant molecules preferably makes up more than 30% by weight, more preferably more than 50% by weight and most preferably more than 70% by weight of the total molecular weight of these non-ionic surfactants.

Other particularly preferred nonionic surfactants with melting points above room temperature contain 40 to 70% of a polyoxypropylene/polyoxyethylene/polyoxpropylene block polymer blend which contains 75% by weight of an inverted block copolymer of polyoxyethylene and polyoxypropylene with 17 moles of ethylene oxide and 44 moles of propylene oxide and 25% by weight of a block copolymer of polyoxyethylene and polyoxypropylene initiated with trimethylol propane and containing 24 moles of ethylene oxide and 99 moles of propylene oxide per mole of trimethylol propane.

Nonionic surfactants, which may be used with particular advantage are obtainable, for example, under the name of Poly Tergent® SLF-18 from Olin Chemicals.

Another preferred surfactant can be described by the following Formula
R¹O[CH₂CH(CH₃)O]ₓ[CH₂CH₂O]_{y}[CH₂CH(OH)R²]
in which R¹ stands for a linear or branched aliphatic hydrocarbon radical with 4 to 18 carbon atoms or mixtures thereof, R² means a linear or branched hydrocarbon radical with 2 to 26 carbon atoms or mixtures thereof and x stands for values between 0.5 and 1.5 and y stands for a value of at least 15.

Other preferred non-ionic surfactants are the end-capped poly(oxyalkylated) non-ionic surfactants corresponding to the following Formula
R¹O[CH₂CH(R³)O]ₓ[CH₂]ₖCH(OH)[CH₂]ⱼOR²
in which R¹ and R² stand for linear or branched, saturated or unsaturated, aliphatic or aromatic hydrocarbon radicals with 1 to 30 carbon atoms, R³ stands for H or for a methyl, ethyl, n-propyl, isopropyl, n-butyl, 2-butyl or 2-methyl-2-butyl radical, x has a value of 1 to 30, k and j have values of 1 to 12 and preferably 1 to 5. Where x has a value of ≧2, each substituent R³ in the above formula may be different. R¹ and R² are preferably linear or branched, saturated or unsaturated, aliphatic or aromatic hydrocarbon radicals containing 6 to 22 carbon atoms, radicals containing 8 to 18 carbon atoms being particularly preferred. H, —CH₃ or —CH₂CH₃ are particularly preferred for the radical R³. Particularly preferred values for x are in the range from 1 to 20 and more particularly in the range from 6 to 15.

As mentioned above, each substituent R³ in the above formula may be different where x is ≧2. In this way, the alkylene oxide unit in the square brackets can be varied. If, for example, x has a value of 3, the substituent R³ may be selected to form ethylene oxide (R³═H) or propylene oxide (R³═CH₃) units which may be joined together in any order, for example (EO)(PO)(EO), (EO)(EO)(PO), (EO)(EO)(EO), (PO)(EO)(PO), (PO)(PO)(EO) and (PO)(PO)(PO). The value 3 for x was selected by way of example and may easily be larger, the range of variation increasing with increasing x-values and including, for example, a large number of (EO) groups combined with a small number of (PO) groups or vice versa.

Particularly preferred end-capped poly(oxyalkylated) alcohols corresponding to the above formula have values for both k and j=1, so that the above formula can be simplified to
R¹O[CH₂CH(R³)O]ₓCH₂CH(OH)CH₂OR²

In this last formula, R¹, R² und R³ are as defined above and x stands for a number from 1 to 30, preferably 1 to 20 and especially 6 to 18. Surfactants in which the substituents R¹ and R² have 9 to 14 carbon atoms, R³ stands for H and x takes a value of 6 to 15 are particularly preferred.

Preferred inventive agents, which are used as automatic dishwasher agents, comprise, in addition to the cited surfactants for improving the washing results, additional amphoteric or cationic polymers.

To increase their cleaning power, agents according to the invention can comprise enzymes, in principle any enzyme established for these purposes in the prior art being useable, their mixtures being preferred. In principle, these enzymes are of natural origin; improved variants based on the natural molecules are available for use in detergents and accordingly they are preferred. The detergents according to the invention preferably comprise enzymes in total quantities of 1×10⁻⁶ to 5 weight percent based on active protein. Protein concentrations can be determined using known methods, for example the BCA Process (bicinchoninic acid; 2,2′-bichinolyl-4,4′-dicarboxylic acid) or the biuret process.

Preferred proteases are those of the subtilisin type. Examples of these are subtilisins BPN′ and Carlsberg, the protease PB92, the subtilisins 147 and 309, the alkaline protease from Bacillus lentus, subtilisin DY and those enzymes of the subtilases no longer however classified in the stricter sense as subtilisins thermitase, proteinase K and the proteases TW3 und TW7. Subtilisin Carlsberg in further developed form is available under the trade name Alcalase® from Novozymes A/S, Bagsvaerd, Denmark. Subtilisins 147 and 309 are commercialized under the trade names Esperase® and Savinase® by the Novozymes company. Variants derived from the protease from Bacillus lentus DSM 5483 are called BLAP®.

Further useable proteases are, for example, those enzymes available with the trade names Durazym®, Relase®, Everlase®, Nafizym, Natalase®, Kannase® and Ovozymes® from the Novozymes Company, those under the trade names Purafect®, Purafect®OxP and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan, and that under the designation Proteinase K-16 from Kao Corp., Tokyo, Japan.

Examples of further useable amylases according to the invention are the α-amylases from Bacillus licheniformis, from B. amyloliquefaciens and from B. stearothermophilus, as well as their improved further developments for use in detergents. The enzyme from B. licheniformis is available from the Company Novozymes under the name Termamyl® and from the Genencor Company under the name Purastar®ST. Further development products of this α-amylase are available from the Company Novozymes under the trade names Duramyl® and Termamyl®ultra, from the Company Genencor under the name Purastar®OxAm and from the Company Daiwa Seiko Inc., Tokyo, Japan as Keistase®. The α-amylase from B. amyloliquefaciens is commercialized by the Company Novozymes under the name BAN®, and derived variants from the α-amylase from B. stearothermophilus under the names BSG® and Novamyl®, also from the Company Novozymes.

Moreover, for these purposes, attention should be drawn to the α-amylase from Bacillus sp. A 7-7 (DSM 12368) and the cyclodextrin-glucanotransferase (CGTase) from B. agaradherens (DSM 9948); similarly the fusion products of the cited molecules can be used.

Moreover, further developments of α-amylase from Aspergillus niger und A. oryzae available from the Company Novozymes under the trade name Fungamyl® are suitable. A further suitable commercial product is, for example Amylase-LT®.

The agents according to the invention can comprise lipases or cutinases, particularly due to their triglyceride cleaving activities, but also in order to produce in situ peracids from suitable preliminary steps. These include the available or further developed lipases originating from Humicola lanuginosa (Thermomyces lanuginosus), particularly those with the amino acid substitution D96L. They are commercialized, for example by the Novozymes Company under the trade names Lipolase®, Lipolase®Ultra, LipoPrime®, Lipozyme® and Lipex®. Moreover, suitable cutinases, for example are those that were originally isolated from Fusarium solani pisi and Humicola insolens. Likewise useable lipases are available from the Amano Company under the designations Lipase CE®, Lipase P®, Lipase B®, and Lipase CES®, Lipase AKG®, Bacillis sp. Lipase®, Lipase AP®, Lipase M-AP® and Lipase AML®. Suitable lipases or cutinases whose starting enzymes were originally isolated from Pseudomonas mendocina und Fusarium solanii are for example available from Genencor Company. Further important commercial products that may be mentioned are the commercial preparations M1 Lipase® und Lipomax® originally from Gist-Brocades Company, and the commercial enzymes from the Meito Sangyo KK Company, Japan under the names Lipase MY-30®, Lipase OF® and Lipase PL® as well as the product Lumafast® from Genencor Company.

Washing or cleaning products, particularly when they are destined for treating textiles, can comprise cellulases, according to their purpose, as pure enzymes, as enzyme preparations, or in the form of mixtures, in which the individual components advantageously complement their various performances. Among these aspects of performance are particular contributions to primary washing performance, to secondary washing performance of the product, (anti-redeposition activity or inhibition of graying) and softening or brightening (effect on the textile), through to performing a “stone washed” effect.

A usable, fungal endoglucanase(EG)-rich cellulase preparation, or its further developments are offered by the Novozymes Company under the trade name Celluzyme®. The products Endolase® and Carezyme® based on the 50 kD-EG, respectively 43 kD-EG from H. insolens DSM 1800 are also obtainable from Novozymes Company. Further commercial products from this company are Cellusoft® and Renozyme®. The 20 kD-EG cellulase from Melanocarpus, obtainable from AB Enzymes Company, Finland under the trade names Ecostone® and Biotouch®, can also be used. Further commercial products from the AB Enzymes Company are Econase® and Ecopulp®. A further suitable cellulase from Bacillus sp. CBS 670.93 is obtainable from the Genencor Company under the trade name Puradax®. Additional commercial products from the Genencor Company are “Genencor detergent cellulase L” and Indiage®Neutra.

The washing or cleaning agents can comprise additional enzymes, which are summarized under the term hemicellulases. These include, for example mannanases, xanthanlyases, pectinlyases (=pectinases), pectinesterases, pectatlyases, xyloglucanases (=xylanases), pullulanases and β-glucanases. Suitable mannanases, for example are available under the names Gamanase® and Pektinex AR® from Novozymes Company, under the names Rohapec® B1L from AB Enzymes and under the names Pyrolase® from Diversa Corp., San Diego, Calif., USA. β-Glucanase extracted from B. subtilis is available under the name Cereflo® from Novozymes Company.

To increase the bleaching action, the washing or cleaning agents can comprise oxidoreductases, for example oxidases, oxygenases, katalases, peroxidases, like halo-, chloro-, bromo-, lignin-, glucose- or manganese-peroxidases, dioxygenases or laccases (phenoloxidases, polyphenoloxidases). Suitable commercial products are Denilite® 1 and 2 from the Novozymes Company. Advantageously, additional, preferably organic, particularly preferably aromatic compounds are added that interact with the enzymes to enhance the activity of the relative oxidoreductases (enhancers) or to facilitate the electron flow (mediators) between the oxidizing enzymes and the stains over strongly different redox potentials.

The enzymes used in the inventive agents either stem originally from microorganisms, such as the species Bacillus, Streptomyces, Humicola, or Pseudomonas, and/or are produced according to known biotechnological processes using suitable microorganisms such as by transgenic expression hosts of the species Bacillus or filamentary fungi.

Purification of the relevant enzymes follows conveniently using established processes such as precipitation, sedimentation, concentration, filtration of the liquid phases, microfiltration, ultrafiltration, mixing with chemicals, deodorization or suitable combinations of these steps.

The enzymes can be added to the inventive agents in each established form according to the prior art. Included here, for example, are solid preparations obtained by granulation, extrusion or lyophilization, or particularly for liquid agents or agents in the form of gels, enzyme solutions, advantageously highly concentrated, of low moisture content and/or mixed with stabilizers.

Alternatively, all enzymes, both for solid as well as for liquid presentation forms, can be encapsulated, for example by spray drying or extrusion of the enzyme solution together with a preferably natural polymer or in the form of capsules, for example those in which the enzyme is embedded in a solidified gel, or in those of the core-shell type, in which an enzyme-containing core is covered with a water-, air- and/or chemical-impervious protective layer. Further active principles, for example stabilizers, emulsifiers, pigments, bleaches or colorants can be applied in additional layers. Such capsules are made using known methods, for example by vibratory granulation or roll compaction or by fluid bed processes. Advantageously, these types of granulates, for example with an applied polymeric film former are dust-free and as a result of the coating are storage stable.

In addition, it is possible to formulate two or more enzymes together, so that a single granule exhibits a plurality of enzymatic activities.

A protein and/or enzyme in an inventive agent can be protected, particularly in storage, against deterioration such as, for example inactivation, denaturation or decomposition, for example through physical influences, oxidation or proteolytic cleavage. An inhibition of the proteolysis is particularly preferred during microbial preparation of proteins and/or enzymes, particularly when the compositions also contain proteases. According to the invention, stabilizers can be added for this purpose.

One group of stabilizers is reversible protease inhibitors. For this, benzamidine hydrochloride, borax, boric acids, boronic acids or their salts or esters are frequently used, above all derivatives with aromatic groups, for example ortho, meta or para substituted phenyl boronic acids, or their salts or esters. Peptide aldehydes, i.e. oligopeptides with a reduced C-terminus, are also suitable. Ovomucoid and leupeptin, among others, belong to the peptidic reversible protease inhibitors; an additional option is the formation of fusion proteins from proteases and peptide inhibitors.

Further enzyme stabilizers are amino alcohols like mono-, di-, triethanol- and -propanolamine and their mixtures, aliphatic carboxylic acids up to C₁₂, such as for example succinic acid, other dicarboxylic acids or salts of the cited acids. End-capped fatty acid amide alkoxylates are also suitable stabilizers.

Lower aliphatic alcohols, but above all polyols such as, for example glycerol, ethylene glycol, propylene glycol or sorbitol are further frequently used enzyme stabilizers. Di-glycerol phosphate also protects against denaturation by physical influences. Similarly, calcium and/or magnesium salts are used, such as, for example calcium acetate or calcium formate.

Polyamide oligomers or polymeric compounds like lignin, water-soluble vinyl copolymers or cellulose ethers, acrylic polymers and/or polyamides stabilize enzyme preparations against physical influences or pH variations. Polymers containing polyamine-N-oxide act simultaneously as enzyme stabilizers and color transfer inhibitors. Other polymeric stabilizers are linear C₈-C₁₈ polyoxyalkylenes. Alkyl polyglycosides can also stabilize the enzymatic components of the inventive agents and in addition, induce them to increase in performance. Crosslinked nitrogen-containing compounds perform a dual function as soil release agents and as enzyme stabilizers.

Reducing agents and antioxidants such as sodium sulfite or reducing sugar increase the stability of enzymes against oxidative decomposition.

The use of combinations of stabilizers is preferred, for example of polyols, boric acid and/or borax, the combination of boric acid or borate, reducing salts and succinic acid or other dicarboxylic acids or the combination of boric acid or borate with polyols or polyamino compounds and with reducing salts. The effect of peptide-aldehyde stabilizers is conveniently increased by the combination with boric acid and/or boric acid derivatives and polyols and still more by the additional effect of divalent cations, such as for example calcium ions.

In the context of the present invention, it is particularly preferred to add liquid formulations of enzymes. According to the invention, it is preferred to introduce the additional enzymes and/or enzyme preparations, preferably solid and/or liquid preparations of protease and or amylase, in amounts of 1 to 5 wt. %, preferably 1.5 to 4.5 wt. % and especially 2 to 4 wt. %, each based on the total agent.

In order to facilitate the disintegration of heavily compacted tablets, disintegration aids, so-called tablet disintegrators, may be incorporated in the basic tablets to shorten their disintegration times. According to Römpp (9th Edition, Vol. 6, page 4440) and Voigt “Lehrbuch der pharmazeutischen Technologie” (6th. Edition, 1987, pages 182-184), tablet disintegrators or disintegration accelerators are auxiliaries, which promote the rapid disintegration of tablets in water or gastric juices and the release of the pharmaceuticals in an absorbable form.

These substances, which are also known as “disintegrators” by virtue of their action, are capable of undergoing an increase in volume on contact with water so that, on the one hand, their own volume is increased (swelling) and, on the other hand, a pressure can be generated through the release of gases which causes the tablet to disintegrate into relatively small particles. Well-known disintegrators are, for example, carbonate/citric acid systems, although other organic acids may also be used. Swelling disintegration aids are, for example, synthetic polymers, such as polyvinyl pyrrolidone (PVP), or natural polymers and modified natural substances, such as cellulose and starch and derivatives thereof, alginates or casein derivatives. All the cited disintegrators can be used according to the invention.

In the context of the present invention, preferred disintegrators are cellulose-based disintegrators, added preferably in granular, cogranulated or compacted form

Pure cellulose has the formal empirical composition (C₆H₁₀O₅)ₙ and, formally, is a β-1,4-polyacetal of cellobiose which, in turn, is made up of two molecules of glucose. Suitable celluloses consist of ca. 500 to 5000 glucose units and, accordingly, have average molecular weights of 50 000 to 500 000. In the contest of the present invention, cellulose derivatives obtainable from cellulose by polymer-analogous reactions may also be used as cellulose-based disintegrators. These chemically modified celluloses include, for example, products of esterification or etherification reactions in which hydroxy hydrogen atoms have been substituted. However, celluloses in which the hydroxy groups have been replaced by functional groups that are not attached by an oxygen atom may also be used as cellulose derivatives. The group of cellulose derivatives includes, for example, alkali metal celluloses, carboxymethyl cellulose (CMC), cellulose esters and ethers and aminocelluloses.

The cellulose derivatives mentioned are preferably not used on their own, but rather in the form of a mixture with cellulose as cellulose-based disintegrators. The content of cellulose derivatives in mixtures such as these is preferably below 50% by weight and more preferably below 20% by weight, based on the cellulose-based disintegrator. A particularly preferred cellulose-based disintegrator is pure cellulose, free from cellulose derivatives. Microcrystalline cellulose can be used as a further cellulose-based disintegrator, or an ingredient of this component. The microcrystalline cellulose is obtained by the partial hydrolysis of cellulose, under conditions, which only attack and fully dissolve the amorphous regions (ca. 30% of the total cellulosic mass) of the cellulose, leaving the crystalline regions (ca. 70%) intact. Subsequent disaggregation of the microfine cellulose, obtained by hydrolysis, yields microcrystalline celluloses with primary particle sizes of ca. 5 μm and for example, compactable granules with an average particle size of 200 μm.

In addition to, or instead of cellulose-based disintegrators, the inventive agent can comprise a gas-liberating system based on organic acids and carbonates/hydrogen carbonates.

Suitable organic acids, which liberate carbon dioxide from carbonates/hydrogen carbonates in aqueous solution are, for example solid mono-, oligo- and polycarboxylic acids. Within this group, citric acid, tartaric acid, succinic acid, malonic acid, adipic acid, maleic acid, fumaric acid, oxalic acid and polyacrylic acid are again preferred. Organic sulfonic acids, such as amidosulfonic acid, may also be used. Sokalan® DCS (trademark of BASF), a mixture of succinic acid (max. 31% by weight), glutaric acid (max. 50% by weight) and adipic acid (max. 33% by weight), is commercially obtainable and may also be used with advantage as an acidifying agent for the purposes of the present invention.

The cited acids need not be added in stoichiometric quantities to the carbonates or hydrogen carbonates contained in the tablets.

In the context of the present invention, the preferred washing and cleaning agent tablet additionally comprises an effervescent system.

In the inventive agents, the gas-releasing effervescent system, in addition to the cited organic acids, consists of carbonates and/or hydrogen carbonates. For reasons of cost, the distinctly preferred representatives of this class of materials are the alkali metal salts. Among the alkali metal carbonates or hydrogen carbonates, the sodium and potassium salts are once again markedly preferred against the other salts for reasons of cost. Naturally, the relevant pure alkali metal carbonates or hydrogen carbonates need not be used; in fact, mixtures of different carbonates and hydrogen carbonates can be preferred.

A wide number of the most diverse salts can be incorporated from the group of inorganic salts as electrolytes. Preferred cations are the alkali and alkaline earth metals, preferred anions are the halides and sulfates. From the industrial manufacturing stand point, the addition of NaCl or MgCl₂ to the inventive granules is preferred.

In order to adjust the pH of the inventive water-soluble container to the desired range, the addition of pH-modifiers may be indicated. All known acids or bases can be added, in so far as their addition is not forbidden on technical or ecological grounds or grounds of consumer protection. Typically, the amount of these modifiers is not more than 1 wt. % of the total formulation.

Several perfume compounds, for example synthetic products of the ester, ether, aldehyde, ketone, alcohol and hydrocarbon type can be used in the context of the invention as perfume oils or fragrances. Perfume compounds of the ester type are, for example, benzyl acetate, phenoxyethyl isobutyrate, p-tert.butyl cyclohexyl acetate, linalyl acetate, dimethyl benzyl carbinyl acetate, phenyl ethyl acetate, linalyl benzoate, benzyl formate, ethyl methyl phenyl glycinate, allyl cyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxyacetaldehyde, cyclamen aldehyde, hydroxycitronellal, lilial and bourgeonal; the ketones include, for example, the ionones, α-isomethyl ionone and methyl cedryl ketone; the alcohols include anethol, citronellol, eugenol, geraniol, linalool, phenyl ethyl alcohol and terpineol and the hydrocarbons include, above all, the terpenes, such as limonene and pinene. However, mixtures of various perfumes, which together produce an attractive perfume note, are preferably used. Perfume oils such as these may also contain natural perfume mixtures obtainable from vegetal sources, for example pine, citrus, jasmine, patchouli, rose or ylang-ylang oil. Also suitable are clary oil, chamomile oil, clove oil, melissa oil, mint oil, cinnamon leaf oil, lime blossom oil, juniper berry oil, vetivert oil, olibanum oil, galbanum oil and laudanum oil and orange blossom oil, neroli oil, orange peel oil and sandalwood oil.

The general description of the perfumes suitable for use in accordance with the invention (see above) represented the various classes of perfumes in general terms. In order to be noticeable, a perfume has to be volatile, its molecular weight being an important factor along with the nature of the functional groups and the structure of the chemical compound. Thus, most perfumes have molecular weights of up to about 200 daltons, molecular weights of 300 daltons and higher being more the exception. In view of the differences in volatility of perfumes, the odor of a perfume or fragrance composed of several perfumes changes during the evaporation process, the odor impressions being divided into the top note, the middle note or body and the end note or dry out. Since odor perception is also based to a large extent on odor intensity, the top note of a perfume or fragrance does not consist solely of readily volatile compounds whereas the end note or dry out consists largely of less volatile, i.e. firmly adhering, perfumes. In the composition of perfumes, more readily volatile perfumes may be fixed, for example, to certain fixatives, which prevents them from vaporizing too rapidly. In the following classification of perfumes into “readily volatile” and “firmly adhering” perfumes, nothing is said about the odor impression or about whether the corresponding perfume is perceived as a top note or middle note.

By means of a suitable selection of the cited fragrances or perfume oils, the odor of the inventive water-soluble container or the solids enclosed therein (product odor) can be influenced as well as for example, the odor of the washing after the cleaning process. Because of its design, particularly because of the opening in the exterior wall, the inventive water-soluble containers—in comparison to completely closed containers—are especially suited to provide a characteristic product odor, this objective being especially met by the use of readily volatile perfumes, while an effective washing odor is advantageously achieved using firmly adherent perfumes. Firmly adhering perfumes, suitable for use in accordance with the present invention are, for example, the essential oils, such as angelica root oil, aniseed oil, amica flowers oil, basil oil, bay oil, bergamot oil, champax blossom oil, silver fir oil, silver fir cone oil, elemi oil, eucalyptus oil, fennel oil, pine needle oil, galbanum oil, geranium oil, ginger grass oil, guaiac wood oil, Indian wood oil, helichrysum oil, ho oil, ginger oil, iris oil, cajeput oil, sweet flag oil, chamomile oil, camphor oil, canaga oil, cardamom oil, cassia oil, Scotch fir oil, copaiba balsam oil, coriander oil, spearmint oil, caraway oil, cumin oil, lavender oil, lemon grass oil, limette oil, mandarin oil, melissa oil, amber seed oil, myrrh oil, clove oil, neroli oil, niaouli oil, olibanum oil, orange oil, origanum oil, palmarosa oil, patchouli oil, Peru balsam oil, petit grain oil, pepper oil, peppermint oil, pimento oil, pine oil, rose oil, rosemary oil, sandalwood oil, celery seed oil, lavender spike oil, Japanese anise oil, turpentine oil, thuja oil, thyme oil, verbena oil, vetiver oil, juniper berry oil, wormwood oil, wintergreen oil, ylang-ylang oil, ysop oil, cinnamon oil, cinnamon leaf oil, citronella oil, citrus oil and cypress oil. However, relatively high-boiling or solid perfumes of natural or synthetic origin may also be used in accordance with the present invention as firmly adhering perfumes or perfume mixtures. These compounds include those mentioned in the following and mixtures thereof: ambrettolide, α-amyl cinnamaldehyde, anethole, anisaldehyde, anis alcohol, anisole, methyl anthranilate, acetophenone, benzyl acetone, benzaldehyde, ethyl benzoate, benzophenone, benzyl alcohol, benzyl acetate, benzyl benzoate, benzyl formate, benzyl valeriate, borneol, bornyl acetate, α-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, methyl heptyne carboxylate, heptaldehyde, hydroquinone dimethyl ether, hydroxycinnamaldehyde, hydroxycinnamyl alcohol, indole, irone, isoeugenol, isoeugenol methyl ether, isosafrol, jasmone, camphor, carvacrol, carvone, p-cresol methyl ether, coumarin, p-methoxyacetophenone, methyl-n-amyl ketone, methyl anthranilic acid methyl ester, p-methyl acetophenone, methyl chavicol, p-methyl quinoline, methyl-β-naphthyl ketone, methyl-n-nonyl acetaldehyde, methyl-n-nonyl ketone, muskone, β-naphthol ethyl ether, β-naphthol methyl ether, nerol, nitrobenzene, n-nonyl aldehyde, nonyl alcohol, n-octyl aldehyde, p-oxyacetophenone, pentadecanolide, β-phenyl ethyl alcohol, phenyl acetaldehyde dimethyl acetal, phenyl acetic acid, pulegone, safrol, isoamyl salicylate, methyl salicylate, hexyl salicylate, cyclohexyl salicylate, santalol, scatol, terpineol, thymene, thymol, γ-undecalactone, vanillin, veratrum aldehyde, cinnamaldehyde, cinnamyl alcohol, cinnamic acid, ethyl cinnamate, benzyl cinnamate. The more readily volatile perfumes include, in particular, the relatively low-boiling perfumes of natural or synthetic origin, which may be used either individually or in the form of mixtures. Examples of more readily volatile perfumes are alkyl isothiocyanates (alkyl mustard oils), butanedione, limonene, linalool, linalyl acetate and propionate, menthol, menthone, methyl-n-heptenone, phellandrene, phenyl acetaldehyde, terpinyl acetate, citral, citronellal.

In order to enhance the esthetic impression of the compositions of the invention, they may be colored with appropriate dyes. Preferred dyes, whose selection presents no difficulty whatsoever to the skilled worker, have a high level of storage stability and insensitivity toward the other ingredients of the composition and towards light, and have no pronounced substantivity toward textile fibers, so as not to stain them.

A hydrotrope or solubilizer is a substance, which causes a difficultly soluble substance to become soluble or emulsifiable in its the presence. There are solubilizers, which enter into a molecular compound with the difficultly soluble substance and those, which act through micelle formation. One can also say that the solubilizer bestows to the “latent solvent” its solvation ability. For the case of water as the (latent) solvent, one mainly uses the term hydrotropica instead of solubilizer and in certain cases, it is better to use emulsifier.

Foam inhibitors, which may be used in the compositions in accordance with the invention, are suitably, for example, soaps, paraffins or silicone oils, which may if desired have been deposited on carrier materials. Inorganic salts such as carbonates or sulfates, cellulose derivatives or silicates and their mixtures, for example, are suitable carrier materials. In the context of the present invention, preferred agents comprise paraffins, preferably unbranched paraffins (n-paraffins) and/or silicones, preferably polymeric, linear silicones, which have the structure (R₂SiO)ₓ and are also described as silicone oils. These silicone oils are normally clear, colorless, neutral, odorless, hydrophobic liquids with a molecular weight between 1000 and 150 000 and viscosities between 10 and 1 000 000 mPa·s.

Suitable anti-redeposition agents (also called soil-repellents), are, for example, nonionic cellulose ethers like methyl cellulose and methyl hydroxypropyl cellulose with a content of from 15 to 30% by weight of methoxy groups and a hydroxypropyl group content of from 1 to 15% by weight, based in each case on the nonionic cellulose ether, as well as polymers known from the prior art, of phthalic acid and/or terephthalic acid, and/or derivatives thereof, especially polymers of ethylene terephthalates and/or polyethylene glycol terephthalates or anionically and/or nonionically modified derivatives thereof. Of these, particular preference is given to the sulfonated derivatives of phthalic acid polymers and of terephthalic acid polymers.

In order to eliminate graying or yellowing of treated textiles, optical brighteners (known as “whiteners”) can be added to the inventive compositions. These substances attach onto the fibers and cause a brightening and a simulated bleach effect, in that they convert part of the invisible UV radiation of sunlight into longer wavelength light, the absorbed ultraviolet light from the sunlight being emitted as weakly blue fluorescence with the result that the yellow tinge of the gray or yellowed washing becomes pure white. Suitable compounds are based on for example, the classes of substances 4,4′-diamino-2,2′-stilbene disulfonic acids (flavonic acids), 4,4′-distyrylbiphenylene, methyl umbelliferones, coumarins, dihydroquinolines, 1,3-diarylpyrazolines, naphthoic acid imides, benzoxazole-, benzisoxazole- and benzimidazole systems, as well as pyrene derivatives substituted with heterocycles.

Graying inhibitors have the function of keeping the dirt detached from the fiber in suspension in the liquor, thus preventing the redeposition of the dirt. Suitable for this purpose are water-soluble colloids, usually organic in nature, examples being water-soluble salts of polymeric carboxylic acids, glue, gelatin, salts of ethersulfonic acids of starch or of cellulose, or salts of acidic sulfuric acid esters of cellulose or of starch. Water-soluble polyamides containing acidic groups are also suitable for this purpose. In addition, soluble starch preparations and starch products other than those mentioned above may be used, examples being degraded starch, aldehyde starches, etc. Polyvinyl pyrrolidone may also be used. Preference, however, is given to the use of cellulose ethers such as carboxymethyl cellulose (Na salt), methyl cellulose, hydroxyalkyl cellulose, and mixed ethers such as methyl hydroxyethyl cellulose, methyl hydroxypropyl cellulose, methyl carboxymethyl cellulose and mixtures thereof.

Since sheet like textile structures, especially those of rayon, viscose rayon, cotton and blends thereof, may tend to crease, because the individual fibers are susceptible to bending, buckling, compressing and pinching transverse to the fiber direction, the compositions produced in accordance with the invention may comprise synthetic crease control agents. These include, for example, synthetic products based on fatty acids, fatty acid esters, fatty acid amides, fatty acid alkylol esters, fatty acid alkylolamides, or fatty alcohols, which are usually reacted with ethylene oxide, or else products based on lecithin or on modified phosphoric esters. A particularly common and suitable substance for textile finishing and care is cotton seed oil, which can be manufactured, for example, by pressing the brown, cleaned cotton seeds, purification with a 10% sodium hydroxide solution or by extraction with hexane at 60-70° C. Typical cotton oils comprise 40 to 55 wt. % linoleic acid, 16 to 26 wt. % oleic acid and 20 to 26 wt. % palmitic acid. Other particularly preferred products for fiber smoothing and fiber care are especially the monoglycerides of fatty acids such as, for example glycerin monooleate or glycerin monostearate.

In order to combat microorganisms, the compositions produced in accordance with the invention may comprise antimicrobial active substances. In this context, a distinction is made, depending on antimicrobial spectrum and mechanism of action, between bacteriostats and bactericides, fungiostats and fungicides, etc. Examples of important substances in these groups are benzalkonium chlorides, alkylarylsulfonates, halophenols, and phenylmercuric acetate, it also being possible to dispense with these compounds entirely in the inventive compositions.

In order to prevent unwanted changes to the compositions and/or the treated textiles resulting from oxygen exposure and other oxidative processes, the compositions may comprise antioxidants. This class of compound includes, for example, substituted phenols, hydroquinones, pyrocatechols and aromatic amines, as well as organic sulfides, polysulfides, dithiocarbamates, phosphites, and phosphonates.

Increased wear comfort may result from the additional use of antistats, which are additionally added to the compositions produced in accordance with the invention. Antistats increase the surface conductivity and thus enable better dissipation of charges that are formed. External antistats are generally substances having at least one hydrophilic molecule ligand, and provide a more or less hygroscopic film on the surfaces. These antistats, which are usually interface-active, may be subdivided into nitrogen-containing (amines, amides, quaternary ammonium compounds), phosphorus-containing (phosphoric esters), and sulfur-containing (alkylsulfonates, alkyl sulfates) antistats. The lauryl-(or stearyl-) dimethylbenzyl ammonium chlorides are suitable as antistats for textiles and as additives to laundry detergents, in which additionally, a finishing effect is obtained.

Water proofing and impregnation processes serve to treat the textiles with substances, which prevent dirt deposition or facilitate their washability. Preferred water proofing and impregnation agents are perfluorinated fatty acids, also in the form of their aluminum and zirconium salts, organic silicates, silicones, polyacrylic acid esters with perfluorinated alcohol moieties or polymerizable compounds linked with perfluorinated acyl or sulfonyl radicals. The dirt repellant treatment with water proofing and impregnation products is often categorized as an easy-care treatment. Penetration of the impregnation agent in the form of solutions or emulsions of the active agent can be facilitated by wetting agents, which diminish the surface tension. An additional area of use for water proofing and impregnation agents is the water repellant treatment of textile goods, tents, tarpaulins, leather, etc., where, in contrast to water proofing, the material pores are not closed and the material remains breathable (hydrophobing). The hydrophobing agent used for hydrophobing covers the textiles, leather, paper, wood etc. with a very thin layer of hydrophobic groups, such as longer alkyl chains or siloxane groups. Suitable hydrophobing agents are e.g. paraffins, waxes, metal soaps etc. with added aluminum or zirconium salts, quaternary ammonium compounds with long chain alkyl radicals, urea derivatives, fatty acid-modified melamine resins, salts of chromium complexes, silicones, organotin compounds and glutaraldehyde as well as perfluorinated compounds. The hydrophobed materials do not feel fatty to the touch; nevertheless, water droplets run off—like with greased materials—without wetting them. Thus, silicone impregnated textiles, for example, have a soft feel and are water and dirt repellant; ink spots, wine, fruit juices and the like are easier to remove.

Non-aqueous solvents, which can be added to the inventive compositions, particularly include the organic solvents, of which only the most important are described here: alcohols (methanol, ethanol, propanol, butanols, octanol, cyclohexanol), glycols (ethylene glycol, diethylene glycol), ether and glycol ethers (diethyl ether, dibutyl ether, anisol, dioxane, tetrahydrofuran, mono-, di-, tri-, polyethylene glycol ether), ketones (acetone, butanone, cyclohexanone), esters (esters of acetic acid, glycol esters), amides and other nitrogen compounds (dimethylformamide, pyridine, N-methylpyrrolidone, acetonitrile), sulfur compounds (carbon sulfides, dimethyl sulfoxide, sulfolane), nitro compounds (nitrobenzene), halogenated hydrocarbons (dichloromethane, chloroform, tetrachloromethane, tri-, tetrachloroethene, 1,2-dichloroethane, chlorofluorohydrocarbons), hydrocarbons (benzine, petroleum ether, cyclohexane, methylcyclohexane, decalin, terpene solvents, benzene, toluene, xylene). As an alternative to the pure solvents, their mixture may also be used, which can advantageously unite the solvent properties of different solvents, for example. Such a solvent mixture that is particularly preferred in the context of the present invention is for example, cleaning gasoline, a mixture of various hydrocarbons that is suitable for dry cleaning, preferably with a C12 to C14 hydrocarbon content above 60 wt. %, particularly preferably above 80 wt. % and especially above 90 wt. %, each based on the total weight of the mixture, preferably with a boiling range of 81 to 110° C.

The inventive agents can comprise rinse softeners for caring for textiles and improving the textile properties, such as a softer “feel” and reduced electrostatic charging (increased wear comfort). The active agents in rinse softener formulations are “esterquats”, quaternary ammonium compounds with two hydrophobic radicals, such as for example, distearyldimethylammonium chloride, which, however, due to its inadequate biodegradability is increasingly replaced by quaternary ammonium compounds, which contain ester groups targeted biodegradation points in their hydrophobic radicals. These types of “esterquats”, with improved biodegradability are obtained, for example, by the esterification of mixtures of methyldiethanolamine and/or triethanolamine with fatty acids and subsequently quaternizing the reaction products with alkylation reactants by the well-known process. Dimethylolethylene urea is also suitable as a stiffening agent.

Silicone derivatives, for example, can be added to the inventive agents to improve the water absorption capacity, the rewettability of the treated textiles and to facilitate ironing of the treated textiles. They also improve the rinsing out performance of the inventive agent by means of their foam-inhibiting properties. Preferred silicone derivatives are, for example, polydialkyl or alkylarylsiloxanes, in which the alkyl groups have one to five carbon atoms and are totally or partially fluorinated. Preferred silicones are polydimethyldisiloxane, which are optionally derivatized and then are aminofunctional or quaternized or possess Si—OH, SiH, and/or SiCl bonds. Further preferred silicones are the polyalkene oxide modified polysiloxanes, i.e. polysiloxanes, which have polyethylene glycol units, for example, as well as polyalkylene oxide modified dimethylpolysiloxanes. In the context of the present invention, further preferred active substances from the field of washing and cleaning products are the protein hydrolyzates, due to their fiber-nurturing action. Protein hydrolyzates are mixtures of products, which are obtained by acidic, basic or enzymatic catalyzed degradation of proteins (albumins). According to the invention, protein hydrolyzates of both vegetal and animal origin can be used. Animal protein hydrolyzates are for example, elastin, collagen, keratin, silk and milk albumin protein hydrolyzates, which can also be in the form of their salts. According to the invention, the use of vegetal origin protein hydrolyzates e.g. soya, almond, rice, pea, potato and wheat protein hydrolyzates is preferred. Although the use of protein hydrolyzates as such is preferred, also amino acid mixtures or individual amino acids, such as, for example arginine, lysine, histidine or pyrroglutamic acid, optionally obtained from elsewhere, can also be used instead. Similarly, the use of derivatives of protein hydrolyzates, for example in the form of their fatty acid condensation products is also possible.

Finally, the compositions according to the invention may also comprise UV absorbers, which attach to the treated textiles and improve the light stability of the fibers. Compounds, which exhibit these desired properties, are, for example, the compounds, which are active via radiationless deactivation, and derivatives of benzophenone having substituents in position(s) 2 and/or 4. Also suitable are substituted benzotriazoles, acrylates, which are phenyl-substituted in position 3 (cinnamic acid derivatives), with or without cyano groups in position 2, salicylates, organic Ni complexes, as well as natural substances such as umbelliferone and the endogenous urocanic acid.

To protect the tableware or the machine itself, the detergents for automatic dishwashers may contain corrosion inhibitors, silver protectors and glass corrosion inhibitors being particularly important for automatic dishwashers. Substances known from the prior art may be used. Above all, silver protectors selected from the group of triazoles, benzotriazoles, bisbenzotriazoles, aminotriazoles, alkylaminotriazoles and the transition metal salts or complexes may generally be used. Benzotriazole and/or alkylaminotriazole are particularly preferred. In addition, detergent formulations often contain corrosion inhibitors containing active chlorine, which are capable of distinctly reducing the corrosion of silver surfaces. Chlorine-free detergents contain in particular oxygen- and nitrogen-containing organic redox active compounds, such as dihydric and trihydric phenols, for example hydroquinone, pyrocatechol, hydroxyhydroquinone, gallic acid, phloroglucinol, pyrogallol and derivatives of these compounds. Salt-like and complex-like inorganic compounds, such as salts of the metals Mn, Ti, Zr, Hf, V, Co and Ce are also frequently used. Of these, the transition metal salts selected from the group of manganese and/or cobalt salts and/or complexes are preferred, cobalt(ammine) complexes, cobalt(acetate) complexes, cobalt(carbonyl) complexes, chlorides of cobalt or manganese and manganese sulfate as well as the manganese complexes below being particularly preferred:
[Me-TACN)Mn^{IV}(m-0)₃Mn^{IV}(Me-TACN)]²⁺(PF₆⁻)₂,
[Me-MeTACN)Mn^{IV}(m-0)₃Mn^{IV}(Me-MeTACN)]²⁺(PF₆⁻)₂,
[Me-TACN)Mn^{III}(m-0)(m-0Ac)₂Mn^{III}(Me-TACN)]²⁺(PF₆⁻)₂
and
[Me-MeTACN)Mn^{III}(m-0)(m-0Ac)₂Mn^{III}(Me-MeTACN)]²⁺(PF₆⁻)₂,
wherein Me-TACN stands for 1,4,7-trimethyl-1,4,7-triazacyclononane and Me-MeTACN stands for 1,2,4,7-tetramethyl-1,4,7-triazacyclononane. Zinc compounds may also be used to prevent corrosion of tableware.

In the context of the present invention, it is preferred to add in addition, at least one silver protector, selected from the group of triazoles, benzotriazoles, bisbenzotriazoles, aminotriazoles, alkylaminotriazoles, preferably benzotriazole and/or alkylaminotriazole in amounts of 0.001 to 1 wt. %, preferably 0.01 to 0.5 wt. % and especially 0.05 to 0.25 wt. %, each based on the total weight of the solids enclosed in the inventive water-soluble containers.

In addition the abovementioned silver protectors, the inventive agents can further comprise one or more substances to reduce glass corrosion. In the context of the present application, it is preferred to add zinc and/or inorganic and/or organic zinc salts and/or silicates, for example the layered crystalline sodium disilicate SKS 6 of Clariant GmbH, and/or water-soluble glasses, for example glasses, which have a weight loss of at least 0.5 mg under the conditions specified in DIN ISO 719, in order to reduce the glass corrosion. Particularly preferred agents comprise at least one zinc salt of an organic acid, preferably selected from the group zinc oleate, zinc stearate, zinc lactate and zinc citrate.

As used herein, and in particular as used herein to define the elements of the claims that follow, the articles “a” and “an” are synonymous and used interchangeably with “at least one” or “one or more,” disclosing or encompassing both the singular and the plural, unless specifically defined otherwise. The conjunction “or” is used herein in its inclusive disjunctive sense, such that phrases formed by terms conjoined by “or” disclose or encompass each term alone as well as any combination of terms so conjoined, unless specifically defined otherwise. All numerical quantities are understood to be modified by the word “about,” unless specifically modified otherwise or unless an exact amount is needed to define the invention over the prior art.

### EXAMPLES

Commercially available, tetragonally shaped tablets of dishwasher agents (V1) with the dimensions 38.60×30.50×15.50 mm and a volume of 17.80 cm³ were placed in a commercial automatic dishwasher. Molded bodies E1 and E3 according to the invention were prepared, which fit in all the automatic dishwashers that the commercial tablets fit, but distinguish themselves by a markedly increased volume. The results are shown in Table 1:

TABLE 1
Adaptability of the molded bodies in dosage chambers

| | | V1 | E1 | E2 | E3 |
|---|---|---|---|---|---|
| | Length | 38.60 | 38.60 | 38.60 | 38.60 |
| | (mm) | | | | |
| | Widthₜₒₚ | 30.50 | 35.80 | 36.10 | 35.80 |
| | (mm) | | | | |
| | Width_{bottom} | 30.50 | 22.70 | 24.90 | 26.60 |
| | (mm) | | | | |
| | Height (mm) | 15.60 | 16.00 | 16.00 | 16.00 |
| | α (°) | 90 | 50 | 55 | 60 |
| | Volume | ca. | ca. | Ca | ca |
| | (cm³) | 17.80 | 19.70 | 19.80 | 20.70 |
| Dosing | Vol. | 0 | 10.7 | 11.2 | 16.3 |
| equip. | Increase | | | | |
| Dishwasher- | over V1 (%) | | | | |
| Example | | | | | |

| | | | | |
|---|---|---|---|---|
| AEG Oko Fav. 80800 | Fits | Fits | Fits | Fits |
| Zanussi-Rex IT 1063 | Fits | Fits | Fits | Fits |
| WRD | | | | |
| Bauknecht GSFP 3988 | Fits | Fits | Fits | Fits |
| WS | | | | |
| AEG Oko Fav. 80820 | Fits | Fits | Fits | Fits |
| Miele G 698 SC | Fits | Fits | Fits | Fits |
| Whirlpool ADG 956 | Fits | Fits | Fits | Fits |
| Indesit DA 62 | Fits | Fits | Fits | Fits |
| Candy CD 475 S | Fits | Fits | Fits | Fits |
| Bosch SMS 4492 | Fits | Fits | Fits | Fits |
| Bosch SGS 0902 | Fits | Fits | Fits | Fits |
| Fagor VFE-07S | Fits | Fits | Fits | Fits |

Table 1 shows that according to the invention the volume can be markedly increased, without losing the fitting accuracy.

Analogously, novel molded bodies (V2) in the shape of a filled, deep drawn, tetragonal article with the dimensions 39.50×30.00×18.50 mm and a volume of 21.10 cm³, were placed in commercial automatic dishwashers. These molded bodies no longer fit into five of the dosing chambers of the above automatic dishwashers. Molded bodies E4 to E6 were prepared according to the invention, which with the same volume should fit into a larger number of dosing chambers or with the same fit rate have a larger volume. The results are shown in Table 2:

TABLE 2
Fit rate of the molded bodies in dosage chambers

| | | V2 | E4 | E5 | E6 |
|---|---|---|---|---|---|
| | Length | 39.50 | 38.60 | 38.80 | 38.80 |
| | (mm) | | | | |
| | Widthₜₒₚ | 30.00 | 35.80 | 37.00 | 37.00 |
| | (mm) | | | | |
| | Width_{bottom} | 30.00 | 26.20 | 27.20 | 26.60 |
| | (mm) | | | | |
| | Height (mm) | 18.50 | 16.60 | 17.00 | 18.00 |
| | α (°) | 90 | 60 | 60 | 60 |
| | Volume | ca. | ca. | ca | Ca |
| | (cm³) | 21.10 | 21.10 | 22.00 | 23.30 |
| Dosing | Vol. | 0 | 0 | 4.3 | 10.4 |
| equip. | Increase | | | | |
| Dishwasher- | over V1 (%) | | | | |
| Example | | | | | |

| | | | | |
|---|---|---|---|---|
| AEG Oko Fav. 80800 | No fit | Fits | No fit | No fit |
| Zanussi-Rex IT 1063 | No fit | No fit | No fit | No fit |
| WRD | | | | |
| Bauknecht GSFP 3988 | No fit | Fits | Fits | No fit |
| WS | | | | |
| AEG Oko Fav. 80820 | Fits | Fits | Fits | Fits |
| Miele G 698 SC | Fits | Fits | Fits | Fits |
| Whirlpool ADG 956 | Fits | Fits | Fits | Fits |
| Indesit DA 62 | No fit | No fit | No fit | No fit |
| Candy CD 475 S | No fit | Fits | No fit | No fit |
| Bosch SMS 4492 | Fits | Fits | Fits | Fits |
| Bosch SGS 0902 | Fits | Fits | Fits | Fits |
| Fagor VFE-07S | Fits | Fits | Fits | Fits |

The Table shows that the inventive molded bodies either with the same volume, fit markedly more dosing chambers (E4) or with a markedly higher volume, fit the same number of dosing chambers (E6) as the comparative example. With a slightly increased volume, a higher fit rate is realized (E5).

1. A molded body comprising a washing or cleaning agent, said body having top and bottom horizontal surfaces defining a height, said top and bottom surfaces being joined by at least two lateral delimiting surfaces, wherein at least one of the lateral delimiting surfaces is not vertical over at least half of the height.

2. The molded body of claim 1, wherein one lateral delimiting surface forms an angle to the horizontal of 30° to 80°.

3. The molded body of claim 2, wherein the one lateral delimiting surface forms an angle to the horizontal of 35° to 75°.

4. The molded body of claim 3, wherein the one lateral delimiting surface forms an angle to the horizontal of 40° to 70°.

5. The molded body of claim 4, wherein the one lateral delimiting surface forms an angle to the horizontal of 50° to 60°.

6. The molded body of claim 1, wherein at least one lateral delimiting surface is not vertical over at least 60% of the height.

7. The molded body of claim 6, wherein the at least one lateral delimiting surface is not vertical over at least 70% of the height.

8. The molded body of claim 7, wherein the at least one lateral delimiting surface is not vertical over at least 75% of the height.

9. The molded body of claim 8, wherein the at least one lateral delimiting surface is not vertical over at least 80% of the height.

10. The molded body of claim 1, comprising four lateral delimiting surfaces, of which at least one is not vertical over at least half of its height.

11. The molded body of claim 1, wherein the top and bottom horizontal surfaces are rectangular, each having a same length t and a different width b.

12. The molded body of claim 1, having rounded corners and/or edges.

13. The molded body of claims 1, having beveled corners and/or edges.

14. The molded body of claim 1, comprising a tablet of solid washing or cleaning agent.

15. The molded body of claim 1, comprising a an enclosure filled with a washing or cleaning agent.
